(19) United States
(12) Patent Application Publication
(10) Pub. No.: US 2026/0138088 A1
(43) Pub. Date: May 21, 2026

(54) CATALYTIC OXIDATION REACTORS FOR THE REMOVAL OF LOW-LEVEL METHANE IN AIR

(71) Applicant: MASSACHUSETTS INSTITUTE OF TECHNOLOGY, Cambridge, MA (US)

(72) Inventors: Desiree PLATA, Concord, MA (US); Asegun HENRY, Boston, MA (US); Anastasios John HART, Waban, MA (US); Qingzi ZHU, Waltham, MA (US); Mehdi PISHAHANG, Waltham, MA (US); Rebecca BRENNEIS, Arlington, VA (US)

(21) Appl. No.: 19/119,601

(22) PCT Filed: Oct. 13, 2023
(86) PCT No.: PCT/US2023/076816

§ 371 Date: Apr. 9, 2025

Related U.S. Application Data
(60) Provisional application No. 63/415,821, filed on Oct. 13, 2022.

(51) Int. Cl. B01D 53/86; B01D 53/34

(52) U.S. Cl. CPC B01D 53/8668; B01D 53/343; B01D 53/8696; B01D 2251/102; B01D 2255/20738; B01D 2255/20753; B01D 2255/20761; B01D 2255/50; B01D 2257/7025; B01D 2258/06

(57) ABSTRACT

A reactor system and method for oxidizing methane can include an environmentally friendly catalyst material that converts methane to an oxidized product at low temperatures and concentrations, for example, to reduce or eliminate methane in coal mine air, dairy barns, oil and gas fields, and direct air conversion applications.

### CLAIM OF PRIORITY

This application claims priority to U.S. Application No. 63/415,821, filed on Oct. 13, 2022, the contents of which is incorporated by reference in its entirety.

### TECHNICAL FIELD

This invention relates to systems and methods of oxidizing methane.

### BACKGROUND

While carbon dioxide is the greenhouse gas at the center of the global climate conversation, methane contributes as much warming over the coming decades. Methane is more potent and much faster acting, yet critically, no control technology exists that can address methane at most of its sources globally. Atmospheric methane concentrations have increased almost twice as fast as CO₂ over this time-frame as well.

### SUMMARY

In general, a system and method for oxidizing methane can reduce methane concentrations in a gas. The gas can include less than 50% methane, less than 20% methane, less than 10% methane, less than 5% methane, less than 1% methane, less than 1000 ppm methane, less than 100 ppm methane, less than 10 ppm methane, or less than 5 ppm methane. The gas can include at least 1 ppb, at least 10 ppb, at least 100 ppb, at least 1 ppm, or at least 2 ppm methane. The gas can be sourced at a coal mine, dairy barn, oil and gas field, landfill, or other location identified as requiring methane abatement. The system and method can use a methane oxidation catalyst. The methane oxidation catalyst can include iron, copper, or nickel. For example, the methane oxidation catalyst can include a copper zeolite, an iron zeolite, or a nickel zeolite, such as copper mordenite.

In one aspect, a system for oxidizing methane can include a reactor housing including a feed gas stream intake, an oxidation region including a methane oxidation catalyst configured to contact a feed gas stream including methane from the gas stream intake, and a gas stream outlet opposite conversion region for the activated methane oxidation catalyst to convert the feed gas stream to an oxidized product at a conversion temperature in the presence of an oxidative agent.

In another aspect, a method of oxidizing methane can include sensing one or more features of a feed gas mixture, and exposing the feed gas mixture including methane in the presence of an oxidative agent to a methane oxidation catalyst to convert the methane to an oxidized product.

In certain circumstances, the system or method can include at least one sensor configured to monitor real-time input feed composition. The sensor can be configured to monitor one or more interfering species. In certain circumstances, the sensor is a chemiresistive sensor.

In certain circumstances, the system or method can include at least one sensor configured to monitor real-time output performance.

In certain circumstances, the system or method can include a signal deconvolution module for analyzing one or more sensor signals. The signal deconvolution module can include a machine learning analysis protocol.

In certain circumstances, the system or method can include a feedback control system. The feedback control system can adjust input feed gas methane concentrations. The feedback control system can adjust oxidative agent concentration.

In certain circumstances, the feed gas stream can include entrained particles.

In certain circumstances, the feed gas stream can have a flow rate of between 0.5-2 million cubic feet per minute (CFM). For example, the feed gas stream can have a flow rate of less than 100 CFM, less than 1000 CFM, less than 10,000 CFM, less than 100,000 CRM, less than 500,000 CRM, less than 1 million CFM, or less than 1.5 million CFM.

In certain circumstances, the feed gas stream can have a flow rate of less than 100 CFM.

In certain circumstances, the conversion temperature can be less than about 500° C.

In certain circumstances, the activated methane oxidation catalyst can be activated at an activation temperature at or below about 500° C. while exposed to an activation gas including less than 100% oxygen for an activation time.

In certain circumstances, the oxidation region can include particles including the methane oxidation catalyst.

In certain circumstances, the oxidation region can include a fixed bed including the methane oxidation catalyst.

In certain circumstances, the system or method can include a heat exchanger configured to flow heat from the oxidized product to the feed gas stream.

In certain circumstances, the methane oxidation catalyst includes an iron zeolite, a nickel zeolite, a copper zeolite, or combinations thereof.

In certain circumstances, the methane oxidation catalyst can include iron, copper, nickel, or combinations thereof.

In certain circumstances, the methane oxidation catalyst can include a metal organic framework, a zeolite, or zeolite monolith, or an aerogel.

In certain circumstances, the system can be a pack bed reactor, fluidized bed reactor, or a monolithic catalytic reactor.

In certain circumstances, one or more feature of the feed gas mixture can provide feedback for conditions of the exposing step.

In certain circumstances, the method can include analyzing the one or more feature of the feed gas mixture with a machine learning algorithm to adjust a parameter of the method.

In certain circumstances, the one or more feature of the feed gas mixture can include relative humidity, methane concentration, oxygen concentration, or interfering species concentrations.

In certain circumstances, the method can include sensing one or more feature of the oxidized product.

In certain circumstances, the method can include analyzing the one or more feature of the oxidized product to provide feedback for conditions of the exposing step.

In certain circumstances, the method can include comprising analyzing the one or more feature of the oxidized product with a machine learning algorithm to adjust a parameter of the method.

In certain circumstances, the one or more feature of the oxidized product can include relative humidity, methane concentration, oxygen concentration, or interfering species concentrations.

In certain circumstances, the feed gas mixture can include less than 4% methane.

In certain circumstances, the oxidative agent can include less than 22% oxygen. In certain circumstances, the oxidative agent can be air.

In certain circumstances, the feed gas can be exposed to the copper doped zeolite at a temperature of, or less than about 500° C.

Other aspects, embodiments, and features will be apparent from the following description, the drawings, and the claims.

### BRIEF DESCRIPTION OF THE DRAWINGS

FIG. 1 is a series of graphs depicting a copper-zeolite catalyst (inset) adapted for conversion of low-level methane to CO₂ that has shown a broad range of reactivity for long timescales at modest temperatures. The effect of (top) temperature (30 min activation), (middle) time (310° C., 8-hr activation step), and (bottom) methane concentration (1.8 ppm-1.8%) on methane conversion are shown. n=10; error bars smaller than symbols.

FIG. 2 is a schematic of an integrated air methane abatement system with catalytic oxidation system. A recuperator and a boiler can be used to reuse the heat of the air methane gas coming out from the reactor.

FIG. 3A is a graph depicting power generation and requirements. Compressor power as a function of pressure loss across the reactor (solid curve), compared to the potential electricity generation at different methane concentrations (hashed lines). Modeled at 100,000 CFM.

FIGS. 3B and 3C are graphs depicting pressure drop as a function of reactor length and reactor diameter as a function of reactor length.

FIG. 4 is a pair of graphs depicting advanced ML approaches that enable unbiased measurement of environmental chemical signals, even in the face of complex mixtures (here, for low-level ammonium in wastewater). Ion-selective electrodes (ISE) typically respond to more than their intended analyte (e.g., NH₄⁺ responds to both K⁺ (dot color) and Na⁺ (not shown)). Left: 3-sensor suite (NH₄⁺, K⁺, and Na⁺) and Nikolsky-Eisenman model reduces but does not remove interference and bias. Right: 3-sensor suite and ML model removes bias and significantly decreased interference. Related ML-enhancements can readily extend to chemiresistive sensors in air.

FIGS. 5A-5C are schematic drawings depicting three types of reactors considered in the design phase. FIG. 5A is a schematic drawing depicting a Packed Bed Reactor (PBR). FIG. 5B is a schematic drawing depicting a Fluidized Bed Reactor (FBR). FIG. 5C is a schematic drawing depicting a Monolithic Catalytic Reactor (MCR).

FIG. 6 is a graph depicting pressure drop versus gas velocity for five pellet sizes in an FBR.

FIG. 7 is a schematic depicting one embodiment of a reactor as described herein (for example, a type of FBR). The right-hand inset illustrates the ratio of heat generated to heat required as a function of input methane concentration, where a heat released-to-heat utilized ratios of 1 or greater indicate net heat generation.

FIG. 8 depicts an example of a system for oxidizing methane.

FIG. 9 depicts an example of a system for oxidizing methane.

FIGS. 10A-10D depict embodiments of reactor geometries.

FIGS. 11A-11C are graphs depicting thermal stability of the copper zeolite catalyst of the reactor.

FIGS. 12A-12F are graphs depicting the poisoning resistance of the copper zeolite catalyst of the reactor.

FIG. 13 is a graph depicting the responsiveness of the copper zeolite catalyst of the reactor to changes in methane concentration.

FIG. 14 is a graph depicting kinetics for oxidation of methane with the copper zeolite catalyst of the reactor.

FIG. 15 is a schematic drawing of a reactor including a heat exchanger.

FIG. 16 is a schematic drawing showing a reactor system.

Other aspects, embodiments, and features will be apparent from the following description, the drawings, and the claims.

### DETAILED DESCRIPTION

In general, a system and method for oxidizing methane can include a methane oxidation catalyst that is activated to create a reactive catalyst that oxidizes methane under relatively mild conditions.

A reactor system and method for oxidizing methane can include an environmentally friendly catalyst material that converts methane to an oxidized product at low temperatures and concentrations, for example, to reduce or eliminate methane in coal mine air, dairy barns, landfill sites, oil and gas fields, and direct air conversion applications. A reactor system can also be used to reduce or eliminate methane originating from wetlands or other natural sources, biomass burning, agriculture, agricultural waste, or fossil fuels. Reduction or elimination can include mitigation of methane. The catalyst material can convert low levels of methane from gaseous streams to non-methane molecules, such as CO₂, methanol, or formaldehyde, or other carbon forms. For example, the system and method can be configured to receive feed gas from a vent, fan system or cap of a landfill site or oil and gas filed where the feed gas has a methane content of up to 40% for a landfill and up to 90% for an oil and gas field. For example, the system and method can be configured to receive feed gas from gas circulation unit in a dairy barn or other location where the feed gas has a methane content of 1.8 ppm to up to 1%. In each scenario, the system and method reduces the methane concentration by converting the methane to an oxidized product using the catalyst material. The catalyst material can be activated at an activation temperature at or below about 500° C. while exposed to an activation gas including less than 100% oxygen for an activation time, and exposing the activated methane oxidation catalyst to a reaction gas mixture including less than 100% methane at a temperature of, or less than about 350° C. in the presence of an oxidative agent including less than 100% oxygen to convert the methane to an oxidized product.

For example, the activation or the oxidation, or both can take place in air or ambient oxygen. Alternatively, the activation can take place by applying an activation additive. The activation additive can be an oxidizing material such as an oxygen source or a peroxide source. The oxidation can take place by applying an oxidative agent. The oxidative agent can be an oxidizing material such as an oxygen source or a peroxide source.

The catalyst material can be a methane oxidation catalyst as described below.

The reactor system design can include a falling particle reactor in which the catalyst is contained on a plurality of particles that fall through an oxidation region of the housing and contacts the feed gas. In another approach, the reactor system design can include a fluidized bed reactor in which the catalyst is contained on a plurality of particles through which the feed gas flows. In another approach, the reactor system design can include a fixed bed reactor in which the catalyst is supported on a fixed porous matrix material over which the feed gas passes. The housing can have a plurality of heating zones, sensors, heat exchangers, gas inlets, gas outlets, and other controllers that monitor and provide feedback to control the oxidation of methane by the system.

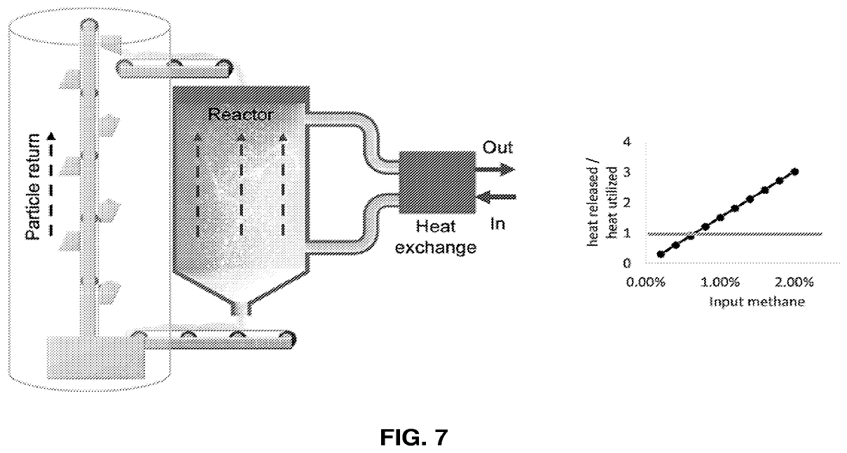

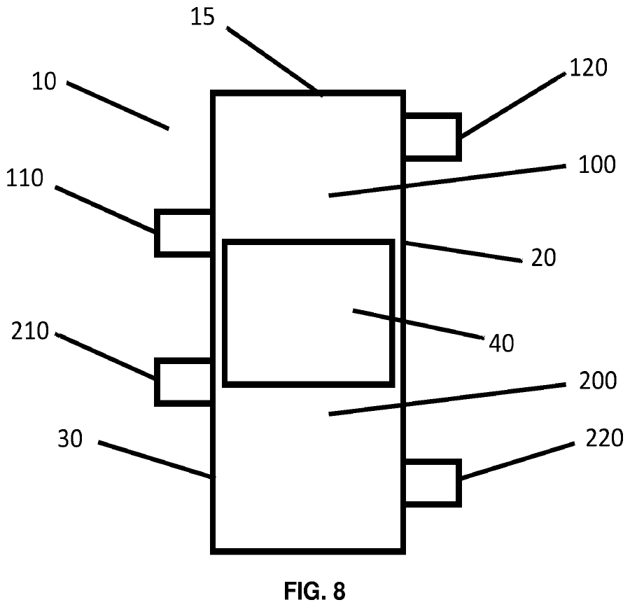

Referring to FIG. 7, a reactor can include a housing in which falling particles help spread the heat released by the reaction to preheat incoming air, while the remainder of the preheating is achieved by a separate recuperative heat exchanger between the unreacted and reacted air methane streams. Particles collected at the bottom are recirculated via conveyor belt. Not shown are input and output sensor diagnostics, controls, energy recovery on outgoing heated air, or necessary prefiltration of particles or interfering.

The system for oxidizing methane can include an oxidation region in which a methane oxidation catalyst contacts a feed gas. FIG. 8 depicts a system for oxidizing methane. Referring to FIG. 8, reactor 10 includes housing 15. Housing 15 includes first chamber 20 and an optional second chamber 30. First chamber 20 and second chamber 30 can be bridged by oxidation region 40. Oxidation region 40 can include a methane oxidation catalyst. Region 100 can be configured for a first gas flow into first chamber 20 via first chamber inlet 110, through or over oxidation region 40 and optional first chamber outlet 210 proximate to optional second chamber 30. The first gas flow can include an oxidative agent. The gas flow through first chamber inlet 110 and first chamber outlet 210 can be used primarily during a catalyst activation cycle. Housing 15 also include gas stream intake 120 and gas stream outlet 220. When operating to oxidize methane, a feed gas stream passes through gas stream intake 120, and over or through the oxidation region 40. The oxidized product can pass through region 200 and out of housing 15 at gas stream outlet 220. In certain circumstances the intake 110 and inlet 120 can be the same inlet. In certain circumstances, the outlet 210 and outlet 220 can be the same outlet. In certain circumstances, the feed gas can include methane and the oxidative agent.

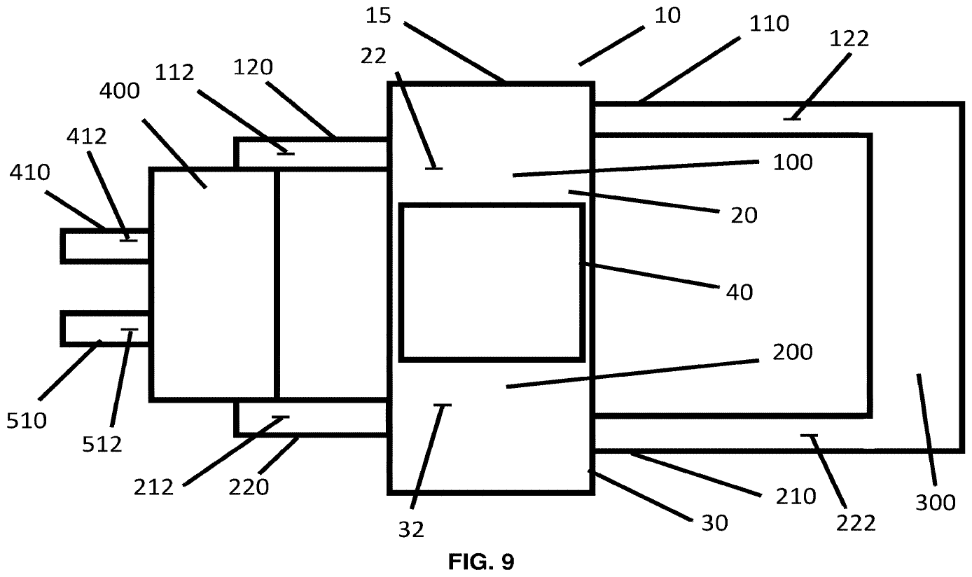

The system for oxidizing methane can include an oxidation region in which a methane oxidation catalyst contacts a feed gas. FIG. 9 depicts a system for oxidizing methane. Referring to FIG. 9, reactor 10 includes housing 15. Housing 15 includes first chamber 20 and an optional second chamber 30. First chamber 20 and second chamber 30 can be bridged by oxidation region 40. Oxidation region 40 can include a methane oxidation catalyst. Region 100 can be configured for a first gas flow into first chamber 20 via first chamber inlet 110, through or over oxidation region 40 and optional first chamber outlet 210 proximate to optional second chamber 30. The first gas flow can include an oxidative agent. The gas flow through first chamber inlet 110 and first chamber outlet 210 can be used primarily during a catalyst activation cycle. Housing 15 also include gas stream intake 120 and gas stream outlet 220. When operating to oxidize methane, a feed gas stream passes through gas stream intake 120, and over or through the oxidation region 40. The oxidized product can pass through region 200 and out of housing 15 at gas stream outlet 220. Gas stream intake 120 can receive a feed gas from intake 410, which can pass through heat exchanger 400. Gas stream outlet 220 can pass through heat exchanger 400 to outlet 510. Heat exchanger 400 can allow heat from housing 15 to transfer and preheat the feed gas to improve efficiency of the system. In certain circumstances, first chamber inlet 110 and first chamber outlet 210 can be used to introduce and remove methane oxidation catalyst from the oxidation region 40. The methane oxidation catalyst can be removed from housing 15 at first chamber outlet 210, and can then pass to regenerator 300. Regenerator 300 can activate the methane oxidation catalyst which can then be returned to the housing 15 by first chamber inlet 110. In certain circumstances, the intake 110 and inlet 120 can be the same inlet. In certain circumstances, the outlet 210 and outlet 220 can be the same outlet. In certain circumstances, the feed gas can include methane and the oxidative agent.

Referring to FIG. 9, one or more sensors can be employed to monitor the performance of the system. For example, optional sensor 22 and sensor 32 can be located in housing 15 and can provide information about one or more feature in the housing. Sensor 22 and sensor 32 can provide one or more sensor signals for methane concentration, interfering species identities, interfering species concentrations, oxidative agent identity, oxidative agent concentration, oxidized product identities, or oxidized product concentration. In another example, optional sensor 112 and sensor 212 can be located in gas stream intake 120 and gas stream outlet 220, respectively. Sensor 112 can provide one or more sensor signals for methane concentration, interfering species identities, interfering species concentrations, oxidative agent identity, or oxidative agent concentration. Sensor 212 can provide one or more sensor signals for methane concentration, interfering species identities, oxidative agent identity, oxidative agent concentration, interfering species concentrations, oxidized product identities, or oxidized product concentration. In another example, optional sensor 412 and sensor 512 can be located in intake 410 and outlet 510, respectively. Sensor 412 can provide one or more sensor signals for methane concentration, interfering species identities, interfering species concentrations, oxidative agent identity, or oxidative agent concentration. Sensor 512 can provide one or more sensor signals for methane concentration, interfering species identities, oxidative agent identity, oxidative agent concentration, interfering species concentrations, oxidized product identities, or oxidized product concentration. In another example, optional sensor 122 and sensor 222 can be located in first chamber inlet 110 and first chamber outlet 210, respectively. Sensor 122 can provide one or more sensor signals for interfering species identities, interfering species concentrations, methane oxidation catalyst identity, or methane oxidation catalyst concentration. Sensor 222 can provide one or more sensor signals for interfering species identities, interfering species concentrations, methane oxidation catalyst identity, or methane oxidation catalyst concentration. Each sensor can be a chemiresistive sensor.

Advantageously, the system and method described herein can be implemented under relatively mild conditions. The system and method can include earth-abundant, low cost catalyst for low level methane abatement. The catalyst starting materials can be easy to source. Preferably, the catalyst oxidizes methane at low temperatures, for example, at temperatures of less than about 500° C., less than about 450° C., less than about 400° C., less than about 350° C., less than about 300° C., or less than about 250° C. The catalyst can be resistant to poisoning by other species in the gas. Examples of other species can include water, hydrogen sulfide, ammonia, nitrogen oxides, sulfur oxides, or volatile organic compounds. In circumstances, the catalyst is durable. For example, the activity of the catalyst is largely unchanged over a period of at least 2 months, at least 3 months, at least 4 months, at least 6 months, at least 9 months, at least 12 months, at least 18 months, at least 24 months, or at least 36 months. Over the time period, the activity can change less than 10%, less than 8%, less than 6%, less than 4%, less than 2%, or less than 1%. For example, the catalyst can operate with less than about 1% decrease in oxidation efficiency over a one year period at 70 percent relative humidity at an operating temperature of 400° C. The catalyst can have greater than 98% reactivity after one year.

The system and method can also include nano-enabled chemiresistive sensors, for example, for methane. The system and method can also include signal deconvolution of interferences with advanced machine-learning. The system and method can also include a heat transfer-optimized reactor for air preheating and energy recovery at power-plant scale (e.g., 5 MW). The system and method can also include a complete, integrated system with controls. As such, the technology could mitigate 42-52 million metric tons of methane globally if deployed at coal mines, potentially reversing the trend of atmospheric methane accumulation.

In one aspect, a system for oxidizing methane can include a reactor housing including a feed gas stream intake, an oxidation region including a methane oxidation catalyst configured to accept a feed gas stream including methane from the gas stream intake, and a gas stream outlet opposite conversion region for the activated methane oxidation catalyst to convert the feed gas stream to an oxidized product at a conversion temperature of, or in the presence of an oxidative agent.

In another aspect, a method of oxidizing methane can include sensing one or more feature of a feed gas mixture, and exposing the feed gas mixture including methane in the presence of an oxidative agent to a methane oxidation catalyst to convert the methane to an oxidized product.

In certain circumstances, the methane oxidation catalyst can be activated at an activation temperature at or below about 500° C. Surprisingly, the activation can take place when exposed to an activation gas including less than 100% oxygen. This contrasts with other systems and methods that require temperatures greater than 500° C. and gas exposure of 100% oxygen to activate a methane oxidation catalysts. Also unexpected is the reactivity of the activated methane oxidation catalyst at relatively low temperatures and under conditions with low methane concentrations and oxygen concentrations. Surprisingly, methane oxidation to an oxidized product, such as methanol, can take place at a temperature of, or less than about 350° C. the presence of less than 100% oxygen gas. An example of a methane oxidation catalyst can include the copper-zeolite catalyst that has been developed (see, for example, PCT Application No. PCT/US2022/030025, which is incorporated by reference in its entirety). Other examples of catalysts are described in U.S. Pat. No. 10,099,979, which is incorporated by reference in its entirety.

In certain circumstances, the methane oxidation catalyst can include iron, copper, or nickel. The methane oxidation catalyst can be a catalyst based on environmentally friendly materials, such as iron or copper. The catalyst can include a support material for the iron, copper or nickel. For example, the methane oxidation catalyst can include a metal organic framework, a zeolite, a zeolite monolith, a clay or an aerogel, which can be the support material. This support material can provide a non-reactive support for the active metal for the methane oxidation catalyst. For example, the methane oxidation catalyst can include a copper zeolite, an iron zeolite, or a nickel zeolite. The zeolite can be a silicoaluminophosphate or an aluminosilicate, such as a pentasil zeolite. For example, the zeolite can be a mordenite or ZSM-5. The methane oxidation catalyst can be made by cation exchange of the support material with the active metal ion, such as the iron, copper, or nickel. These materials can be constructed into structured materials following the ion exchange preparation. The materials can be printed, extruded, heat cured, dip coated, spin coated, or ball milled into a geometries, including a monolith or a pellet.

The methane oxidation catalyst can be activated with an activation gas at an activation temperature for an activation time. The activation time can be 12 hours, 10 hours, 8 hours, 6 hours, or less. In certain circumstances, the activation time can be 240 minutes or less, 180 minutes or less, 120 minutes or less, or 90 minutes or less. The system and method described herein can have a short activation time, which allows for rapid reactivation of the methane oxidation catalyst as necessary. In certain circumstances, the activation gas can include an inert gas. The inert gas can be helium, argon or nitrogen, or mixtures thereof. In certain circumstances, the activation gas can be air. In certain circumstances, the activation gas can be the treatment gas.

In certain circumstances, the activation gas can include less than 80% oxygen, less than 60% oxygen, less than 40% oxygen, or about 20% oxygen. For example, the activation can take place effectively at ambient oxygen levels, such as the oxygen content in air. This can allow activation to take place without the need for any specialty gases.

In certain circumstances, the activation temperature can be below about 500° C., below about 450° C., below about 400° C., below about 350° C., below about 300° C., or below about 250° C. The activation temperature can be as high as 550° C. in the presence of 20% oxygen, which is an unexpected improvement because of the reduced oxygen content required to activate the catalyst.

In certain circumstances, the activation temperature can be below about 900° C., or below about 850° C. and the conversion temperature can be between 60° C. and 90° C., for example, 85° C.

The oxidation of methane to an oxidized product by the activated methane oxidation catalyst can take place at a temperature of, or less than about 350° C. in the presence of an oxidative agent including less than 100% oxygen. In certain circumstances, the oxidative agent can include a solid, for example, metal cofactors such as iron, silver, manganese or lead. In certain circumstances, the oxidative agent can include a liquid, for example, hydrogen peroxide, hypohalous acids and equilibrating species, dissolved peroxidases, and other liquid oxidants. The oxidative agent can enhance the reactivity of the catalyst. In certain circumstances, the oxidative agent can include a gas including oxygen gas, for example, oxygen in an inert carrier gas or in air. For example, the oxidative agent can include less than 100% oxygen, less than 40% oxygen, less than 30% oxygen, or about 20% oxygen. The oxidative agent can be a combination of one or more of these agents.

In certain circumstances, the system and method can be isothermal. In this example, the temperature is held constant, for example between 200 and 600° C., between 250 and 500° C., or between 300 and 450° C. Higher humidity can operate at higher temperatures. The activation is accomplished by exposing the methane oxidation catalyst to an oxidative agent in the absence of methane. The activation can be accomplished by exposing the methane oxidation catalyst to an oxidative agent in the presence of methane. The activation temperature and the conversion temperature can be below 585° C. In certain circumstances, the activation temperature and the conversion temperature can be the same temperature. The air with methane passes over the methane oxidation catalyst and activates it, improving the conversion yield with time. The exposure can be for an activation period of time of, for example, 10 minutes, 20 minutes, 30 minutes, 40 minutes, 50 minutes, 60 minutes, 90 minutes, or 120 minutes. The activated methane oxidation catalyst can then be exposed to a gas including methane, which is then converted to an oxidation product at the same temperature. In this way, the methane oxidation catalyst is activated (or reactivated) simply by changing the atmosphere to which the catalyst is exposed or by continuous exposure of the catalyst to elevated temperature, for example, 300° C. to 500° C.

Unexpectedly, the system and method described herein can oxidize methane when present in relatively low concentrations. In other systems, methane concentrations of more than near 50%, and often near 100%, are needed to observe oxidation products. Using the system and method described herein, the reaction gas mixture can include less than 50% methane, less than 20% methane, less than 10% methane, less than 5% methane, less than 1% methane, less than 1000 ppm methane, less than 100 ppm methane, or less than 10 ppm methane. The methane concentration in a gas to be treated by the catalyst in the reactor can be greater than 0.0001%, greater than 0.0001%, greater than 0.001%, greater than 0.01%, greater than 0.1%, greater than 0.2%, greater than 0.4%, greater than 0.5%, or greater than 0.6%. The methane concentration in a gas to be treated by the catalyst in the reactor can be less than 10%, less than 5.0%, less than 3.0%, less than 2.0%, less than 1.0%, less than 0.8%, or less than 0.6%. The methane concentration in a gas to be treated by the catalyst in the reactor can be between 0.01% and 5.0%, between 0.05% and 3.0%, or between 0.1% and 2.0%. The conversion rate increased over a range of methane concentrations (0.00019-2%), indicating the potential to abate methane from any sub-flammable stream. Oxidation of methane of less than 1000 parts per million concentrations of methane with environmentally friendly catalyst such as a copper or iron zeolite with heat under ambient atmosphere creates opportunities to create systems that have a positive impact on the environment by reducing greenhouse gas impact.

The oxidized products can include methanol, carbon dioxide, and other oxidative products of methane. The conversion efficiency of the methane can be at least 5%, at least 10%, at least 20%, at least 30%, at least 40%, at least 50%, at least 75%, at least 90%, at least 95%, or nearly 100%.

In certain circumstances, the system or method can include at least one sensor configured to monitor real-time input feed composition. The sensor can be configured to monitor one or more interfering species. In certain circumstances, the sensor can be a thermal conductivity detectors, an optical sensor, a spectroscopic sensor, or a chemiresistive sensor. In certain circumstances, the system or method can include at least one sensor configured to monitor real-time output performance. In certain circumstances, the method can include sensing one or more feature of the oxidized product. Each sensor can be configured to detect one or more of the following features of the system, including methane concentration, interfering species identities, interfering species concentrations, oxidative agent identity, oxidative agent concentration, methane oxidation catalyst identity, methane oxidation catalyst concentration oxidized product identities, or oxidized product concentration. Examples of suitable sensors are described in U.S. Patent Publication No. 2021-0341405 A1, which is incorporated by reference in its entirety.

The sensor can be used to detect an analyte. In general, the sensor includes a composition. The composition can include a semiconducting material, an oxidation catalyst proximate to the semiconducting material, and an oxidation enhancer associated with the oxidation catalyst. The oxidation catalyst can be associated with the semiconducting material through a covalent or non-covalent functionalization. Electronic properties of the composition can change in the presence of the analyte. For example, a conductivity property of the semiconducting material can change in the presence of the analyte because of an oxidation reaction promoted by the oxidation catalyst, the oxidation enhancer, or the combination thereof. The conductivity property can include conductance, resistance, or another property of the composition. For example, increased conductivity can be used to change the frequency of an associated resonance circuit that can be excited electrically of with electromagnetic radiation.

The oxidation catalyst affiliated with the sensor is proximate to the semiconducting material. The oxidation catalyst interacts interact with the semiconductor material in a way that changes its conductivity. The oxidation catalyst can undergo electron transfer or partial change transfer with the semiconductor. The oxidation catalyst could additionally switch between states as part of the catalytic cycle that modulates local electrostatic interactions that impede or enhance carrier (holes or electrons) transport in the semiconducting material. This effect can be the result of geometry changes or changes in the coordination about the catalyst. For example, the oxidation catalyst can be bound to a ligand that is covalently anchored to a carbon nanotube. The oxidation catalyst can also directly interact with the semiconductor and for example could be bound to either oxygen or sulfur atoms in the case that the semiconductor is inorganic. For a carbon containing semiconductor it could be bound to nitrogen or carbon groups. Alternatively, the oxidation catalyst can be present in a carrier, such as a fluorocarbon oil, that is in contact with the semiconductor material. In this case the catalyst can be reversibly associating and dissociating with the semiconductor. It is also possible that another molecule or nanoparticle in the mixture could mediate the charge transfer events between the catalyst and the semiconductor. In this case, methane, oxygen and other gases can diffuse into the oil. In some cases, it may be advantageous to have a porous polymer overcoating over the semiconductor material that contains the catalyst and/or oxidation enhancer. In this context, porous indicates a material in which gas can diffuse. In some cases, the porous polymer can concentrate the methane from its surroundings. In another example, the oxidation catalyst can be deposited by evaporation of a solution on the semiconductor material. The proximity leads to a sensor in which conductivity of the semiconducting material changes when the oxidation catalyst is interacting with the analyte, such as methane.

The semiconductor material can include a semiconductor nanowire, a nanocarbon material, a network of semiconductor nanowires, or a semiconductive solid. In certain circumstances, the semiconductor material can include a carbon nanotube, graphene, p-type non-carbon based semiconductor, inorganic semiconductor, or n-type semiconductor. The p-type non-carbon based semiconductor can be SnO, MoS₂, CuO or NiO. The n-type semiconductor can be SnO₂, TiO₂, V₂O₅, WO₃, MoO₃ or ZnO. For example, the semiconductor material can be a single-walled carbon nanotube or a plurality of single-walled carbon nanotubes.

In certain circumstances, the semiconductor material can be modified to covalently bind the oxidation catalyst. In certain circumstances, the semiconductor materials can function as the oxidation enhancer in the composition, for example, in compositions including TiO₂, V₂O₅, WO₃, and MoO₃.

The composition can include a polymer associating the oxidation catalyst with the semiconducting material. In this embodiment, the polymers can be organized into three classes. Type I polymers immobilize the metal catalyst by coordination or electrostatic attraction of a charged group. Type II porous polymers contain large free volumes and are good hosts for catalytically active nanoparticles. Type III coordination polymers that can include metal oxides, metal sulfides, metal halides, silica sol-gels, silicates, metal ligand compositions, or mixtures thereof. In some cases, materials such as the metal oxides can function as catalysts themselves or may host additional metals. In all cases, the composite is expected to efficiently oxidize an analyte, such as methane, and give rise to a sensing response.

In certain circumstances, the polymer can be a vinyl-based polymer, such as poly(4-vinylpyridine) (P4VP). In accordance with the Type I, Type II and Type III polymer classes, the polymer can be hyperbranched, the polymer backbone can contain non-carbon elements, be completely composed of inorganic elements, or the polymer can have a porous structure, or combinations of these features. For example, the polymer can be produced from condensation of metal or main group element with other elements from groups 15, 16 of 17. In certain embodiments, the group 16 element can contain oxygen or sulfur. In other cases, the polymer can be generated by hydrolysis of precursors to give oxide materials. For example, Si(OC₂H₅)₄ can be hydrolyzed to create silicate polymers and the addition of organic groups can be readily incorporated by including R—Si(OC₂H₅)₃ as the sole silicon group or as a component of the composition. Similar polymers can be generated based on phosphorous in its +5 high oxidation state. For example, polyphosphoric acid could be the polymer used in conjunction with other materials. The R group attached to the polymer can be any molecular fragment that produces desirable properties. For example, some cases R can have an affinity for methane and in other cases R can be used to interact with the oxidation catalyst or oxidation enhancer.

The oxidation enhancer is a component that interacts with the oxidation catalyst to improve the performance of the catalyst, in terms of efficiency, turnover rate, selectivity, or combinations thereof. The oxidation enhancer can include a polyoxometalate, for example, a tungsten polyoxometalate or a molybdenum polyoxometalate. The polyoxometalate can include phosphorous, platinum, tungsten, molybdenum, copper, iron, osmium, cobalt, rhodium, palladium, vanadium, osmium, gold, cerium, iridium, iron, manganese, silver, or europium. In certain embodiments, the oxidation enhancer can include a polymer, an inorganic oxide, nanoparticles, or a porous solid.

In the composition, the oxidation catalyst is a catalyst that oxidizes the analyte. The oxidation catalyst can include a molecular oxidation catalyst such as a molecular methane oxidation catalyst. The oxidation catalyst can include a metal or metal ion. The oxidation catalyst can include platinum, tungsten, molybdenum, copper, iron, osmium, cobalt, rhodium, palladium, vanadium, osmium, gold, cerium, iridium, iron, manganese, silver, or europium, or combinations thereof. For example, the oxidation catalyst can be a platinum complex, EuCl₃, Eu(CH₃CO₂)₃, Eu₂(CO₃)₃, Eu₂(NO₃)₃, [(n-Bu₄N]VO₃-pyrazine-2-carboxylic acid-H₂O₂, VO(acetylacetonate)₂, VOF₃-(CF₃CO)₂O, V₂O₅—(CF₃CO)₂O, Pd(CH₃CO₂)₂, RhCl₃, CoCl₂, OsCl₃, FeCl₃, CuCl₂, or [(n-Bu)₄N]₄[W₁₀O₃₂]-UV light, or combinations thereof. In certain embodiments, the oxidation catalyst can include nanoparticles. In some cases, these nanoparticles are metal nanoparticles composed of one of more types of metallic element. The polymer structures can be used to stabilize small high activity metal nanoparticles that are more reactive with methane. The metal nanoparticles can have other groups associated with their surfaces that enhance reactivity.

A method of preparing a sensor for detecting an analyte can include placing a substrate, a semiconducting material, an oxidation catalyst proximate to the semiconducting material, and an oxidation enhancer associated with the methane oxidation catalyst in electrical communication with at least two electrodes. A method of sensing an analyte can include exposing a sensor to a sample, and measuring an electrical property of the sensor. The electrical property can be determined directly through wiring it in a circuit or can be read by a change in the resonant characteristics of the circuit. For example, a circuit can be tuned to resonate at a frequency that is used for radio signals. This can result in a circuit that can be powered and read by radio waves and such technology result in sensors that can be read and powered even by a smartphone. The sensor can detect the analyte, for example, methane, by a change in conductivity or electrical characteristics of a circuit containing the sensor.

In certain embodiments, a sensor can include a conductive region in electrical communication with at least two electrodes, where the conductive region includes a composite. In certain embodiments, the polymer can include a nitrogenous group available to form a covalent bond with a linker. In certain embodiments, the linker can form a quaternary nitrogen bond with the polymer. In certain embodiments, the linker is derived from an alkyl halide group. The nitrogenous group is a group having a nitrogen nucleophilic nitrogen atom. The nitrogenous group can be a pendant amino, pyridyl, pyrimidyl, oxazolyl, parazole, imidazole, thiazole, quinolinyl, purinyl, or isoquinolinyl moiety. In certain embodiments, the linker on the substrate can be activated to bind the polymer by dehydration reaction with activating electrophiles such as thionyl chloride of triflic anhydride. In certain embodiments, the composite includes a carbon nanotube that is functionalized with poly(4-vinylpyridine) (P4VP). The functionalization can be non-covalent. The sensor can behave as a dosimeter giving an integrated (irreversible) response to a desired analyte.

Carbon nanotubes are members of the fullerene structural family. These sheets are rolled at specific and discrete (chiral) angles (also known as “helicities”), and the combination of the rolling angle and radius decides the nanotube properties. Nanotubes are categorized as single-walled nanotubes (SWNTs) and multi-walled nanotubes (MWNTs). Individual nanotubes naturally align themselves into “ropes” held together by van der Waals forces.

Applied quantum chemistry, specifically, orbital hybridization best describes chemical bonding in nanotubes. The chemical bonding of nanotubes is composed entirely of sp² bonds, similar to those of graphite. These multiple bonds, which are stronger than the individual single sp³ bonds found in alkanes and diamond, provide nanotubes with their unique strength.

Covalent functionalization is based on the formation of a covalent linkage between functional entities and the carbon skeleton of nanotubes. It could also be divided into direct covalent sidewall functionalization and indirect covalent functionalization with carboxylic groups on the surface of CNTs. Direct covalent sidewall functionalization is associated with a change in hybridization from sp² to sp³ and a simultaneous loss of conjugation. In some cases, two carbons next to each other can be functionalized and a ring structure can connect functional groups to the graphene surface of the CNT. Ligands that interact with the catalyst can be attached to the CNTs. Indirect covalent functionalization takes advantage of chemical transformations of carboxylic groups at the open ends and defects in the sidewalls. These carboxylic groups might have existed on the as-grown CNTs and also be further generated during oxidative treatments. In order to increase the reactivity of CNTs, the carboxylic acid groups usually need to be converted into acid chloride and then undergo an esterification or amidation reaction.

Non-covalent functionalization is mainly based on supramolecular complexation using various adsorption forces, such as van der Waals force, hydrogen bonds, electrostatic force, and π-stacking interactions. Compared to the chemical functionalization, non-covalent functionalization has the advantages that it could be operated under relatively mild reaction conditions and the graphitic electronic structure of CNTs could be maintained with minimal disruption.

In certain embodiments, a sensor can include a composite of a polymer and SWCNTs immobilized onto a substrate. In certain embodiments, the substrate can include metal electrodes, and a linker can be grafted on the substrate. The linker can connect the substrate and the composite of the polymer and SWCNTs. In certain embodiments, the linker can covalently bond the polymer to the substrate. In other cases, the polymers can be bound by electrostatic or ionic interaction to the substrate. For purely inorganic polymers, including metal oxides and metal sulfides, the grafting interactions will involve many ionic or electrostatic interactions as well as bonding. In certain embodiments, metal nanoparticles or ions can be further included as a metal sensitizer to confer further selectivity or sensitivity to the device. The metal nanoparticles or ions can be coordinated by residual moieties in the polymer that are not consumed by grafting to the substrate. In certain embodiments, the polymer can act as a ligand for a variety of metal ions. By incorporating a specific metal ion, the sensor can selectively detect an analyte.

The substrate can be either rigid or flexible. In certain embodiments, the substrate can be made of rigid materials, such as glass, plastic, wood, concrete, rocks, metal chalcogenides, rigid polymers and their composites, passivated metals, bone, asphalt, graphite, silicon, semiconductors, a resonant circuit, ceramics, marble, or granite. In certain embodiments, the substrate can be made of flexible materials, such as paper, polymers, skin, cloth, tissue, plants, leather, thin sheets of semiconductors or metals, and tires.

In certain embodiments, the electrodes can include graphite, copper, aluminum, gold, or silver.

In certain embodiments, the linker can include an alkyl halide group. For example, the linker can be 3-bromopropyltrichlorosilane.

In certain embodiments, metal nanoparticles can include silver, copper, gold, mercury, zinc, cobalt, rhodium, iridium, nickel, platinum, palladium, iron, ruthenium, manganese, tin, lead oxides or sulfides thereof.

For example, the glass substrate was patterned with gold electrodes and then subjected to grafting between gold electrodes and then subjected to organosilanization with 3-bromopropyltrichlorosilane. The resulting pendant alkyl bromide groups on the glass surface are then available to undergo quaternization chemistry with the pyridyl groups in a composite of P4VP and SWCNTs, thereby covalently bonding the polymer to the substrate. Residual pyridyl groups in the P4VP that are not consumed in the quaternization can subsequently be used to coordinate metal nanoparticles or metal ions chosen to confer further selectivity or sensitivity to the device. Many other ligands are possible to attach to the polymers and can include chelating ligands, carboxylates, phosphonates, sulfoxides, and ethers.

In certain circumstances, the method can include analyzing the one or more feature of the feed gas mixture with a machine learning algorithm to adjust a parameter of the method. The one or more feature of the feed gas mixture can include relative humidity, methane concentration, oxygen concentration, or interfering species concentrations. In certain circumstances, the method can include comprising analyzing the one or more feature of the oxidized product with a machine learning algorithm to adjust a parameter of the method. In certain circumstances, the one or more feature of the oxidized product can include relative humidity, methane concentration, oxygen concentration, or interfering species concentrations. The system or method can include a signal deconvolution module for analyzing one or more sensor signals.

In certain circumstances, the system or method can include a feedback control system. The feedback control system can adjust input feed gas methane concentrations. The feedback control system can adjust oxidative agent concentration. In certain circumstances, one or more feature of the feed gas mixture can provide feedback for conditions of the exposing step. In certain circumstances, the method can include analyzing the one or more feature of the oxidized product to provide feedback for conditions of the exposing step. The signal deconvolution module can include a machine learning analysis protocol. In certain circumstances, methane content can be measured in the feed gas stream and an outlet gas stream.

The system can include a reactor, such as a reactor described in U.S. Pat. No. 10,633,592, which is incorporated by reference in its entirety. A reactor system can include a reaction vessel comprising a reactant, a heat transfer fluid and a first reaction product, wherein the heat transfer fluid has a greater density than the first reaction product such that at least a portion of the first reaction product floats on a surface of the heat transfer fluid; a first outlet positioned at a surface level of the first reaction product, the first outlet configured to output a first outlet flow comprising at least a portion of the first reaction product and at least a portion of the heat transfer fluid; wherein the heat transfer fluid is configured to provide thermal energy to the reactant in the reaction vessel to form the first reaction product.

In certain circumstances, a feed gas stream can include entrained particles. The feed gas stream can have a flow rate of between 0.5-2 million cubic feet per minute (CFM). For example, the feed gas stream can have a flow rate of less than 100 CFM, less than 1000 CFM, less than 10,000 CFM, less than 100,000 CRM, less than 500,000 CRM, less than 1 million CFM, or less than 1.5 million CFM. In certain circumstances, a collection of ˜200,000 CFM units can be put together to handle high flow rates. The feed gas stream can have a flow rate between 50,000-500,000 CFM. The feed gas stream can be split into several smaller flow sections that function in parallel to achieve high total flow rates (e.g., quantity nine, 50,000 CFM reactors to accommodate a total flow of 450,000 CFM). Alternatively, the feed gas stream can have a flow rate of less than 250 CFM.

The conversion temperature can be less than about 500° C. In certain circumstances, the conversion temperature can be about 300° C. to 310° C. The relative humidity can be less than 20%, less than 10%, or less than 5%, where the conversion temperature can be between 300° C. to 350° C.

The system can be a packed bed reactor, fluidized bed reactor, or a monolithic catalytic reactor. In the system, the oxidation region can include particles, beads, or other geometries (e.g., “helicopter seed” shaped) including the methane oxidation catalyst. For example, the oxidation region can include a fixed bed including the methane oxidation catalyst or a fluidized bed including the methane oxidation catalyst. The system or method can include a heat exchanger configured to flow heat from the oxidized product to the feed gas stream. For example, in a fluidized bed reactor, entrained particles can shear in the reactor and then be entrained out of the reactor. In certain circumstances, the entrained particles can be pass to a particle recovery system at an outlet of the system.

As described, the system can include real-time sensing of input gas composition based on novel, small sensors measuring H₂S and CH₄ independently, along with H₂O and particle sensors. ML-assisted signal deconvolution can be used with real-time feedback can help optimize process conditions to address up to 20-fold possible variation in methane input concentration.

In certain circumstances, particles, water, and H₂S can be separated upstream of the catalyst to avoid catalyst poisoning or clogging of the system.

Both falling particle and fixed reactor modes can have counter-current pre-heating of incoming air and heat exchange to leverage the excess heat generated by the reaction for electricity generation.

Specific techno-economic issues related to ventilation air methane (VAM) in coal mines or other ventilation systems for distinct applications will be addressed using an integrated system. The copper-zeolite catalyst that has been developed (see, for example, PCT Application No. PCT/US2022/030025, which is incorporated by reference in its entirety) is low cost ($0.15-0.82/lb), non-toxic, and relies on abundant materials that can remove methane over four orders of magnitude (0.00018-1.8% CH₄) at modest temperatures (e.g., 310° C. in air). The system will include real-time sensing of input gas composition based on novel, small sensors measuring CH₄ and other analytes (e.g., H₂S) independently, along with H₂O and particle sensors. ML-assisted signal deconvolution will be developed and real-time feedback can improve or optimize process conditions to address 10-fold possible variation in methane input concentration. Upstream separation of particles, water, and H₂S will be incorporated into the system if needed to avoid catalyst poisoning or clogging. To handle the extreme air methane flowrates, the final system must be large (500,000 CFM at deployment scale, possibly comprised of smaller 50,000-100,000 CFM reactors). To achieve this, two main reactor modes are possible: falling particles and fixed reactors. Both reactor modes can have counter-current pre-heating of incoming air and heat exchange to leverage the excess heat generated by the reaction for electricity generation. Catalyst performance under these modes, the sensors, ML and feedback controls can be tested and integrated to function in field applications. The complete system can be interfaced to a VAM shaft, but can operate as a stand-alone unit. This system design can help avoid unnecessary disruptions to ventilation air systems required for the safe operation of mines, but with the added benefits of dramatically reduced climate forcing and enhanced sustainability.

The stand-alone system described herein integrates at least four key important features:
Copper-zeolite catalyst to convert low-levels of methane at low temperatures
Continuous flow, thermochemical reactors optimizing for yield, energy efficiency, and energy production
Chemiresistive sensors for methane and other gases, such as H₂S
Machine learning approaches to improve precision and accuracy in multi-sensor arrays

Progress in ventilation methane mitigation has been limited by three principal challenges: (1) fluctuating, low-level input methane (0.2-2%), (2) safety concerns associated with operating powered, high-temperature equipment near a methane source, such as a mine, and (3) the extreme flow rates required for operation and to avoid ventilation air interruption. Additionally, two key challenges for almost any system to address low level ventilation methane in the field can include: (4) interfering species that convolute real-time sensing efforts and threaten to clog or poison the system and (5) life-cycle impacts (capital and operating energy footprints) that offset the net benefit of the greenhouse gas (GHG) mitigation technology. Overcoming these challenges can hinge on several key innovations, ultimately related to having a robust, selective methane conversion technology, the ability to sense methane levels in the face of other interfering chemicals, and a reactor design that can transform the economic feasibility calculus from a net cost to a net benefit.

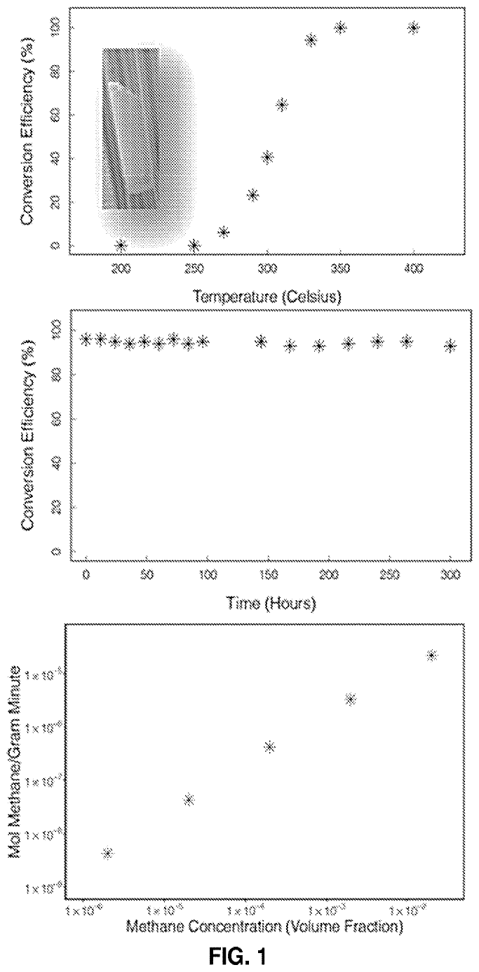

One technical feature that can be used in the system includes Cu-zeolite catalyst that operates at or below 310° C. to continuously convert methane to CO₂ over four orders of magnitude of low-level methane (0.00018%-1.8%) within 30 second residence times (FIG. 1 and see PCT Application No. PCT/US2022/030025, which is incorporated by reference in its entirety). This catalyst has shown continuous operation over at least two weeks with no signs of deterioration in catalyst performance in simulated air. The innovation inherently overcomes safety concerns associated with operating reactors at 600-1000° C. (Refs. 6-9), the temperatures required for other proposed conversion technologies (e.g., Regenerative Thermal Oxidation (RTO), Regenerative Catalytic Oxidation (RTO), and Catalytic Recuperative Oxidation (CRO)).

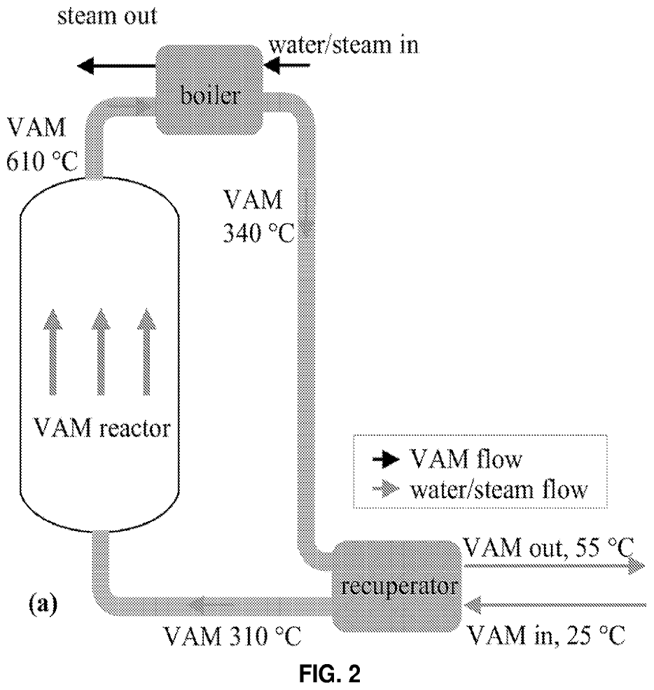

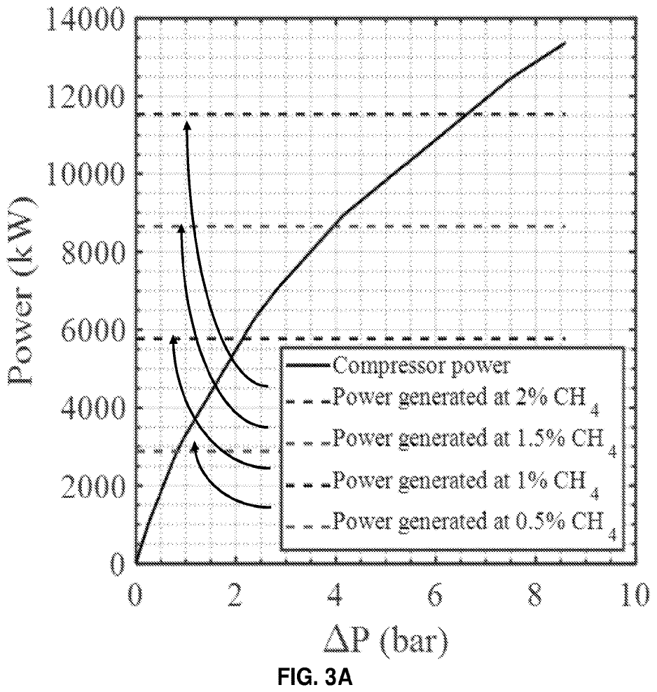

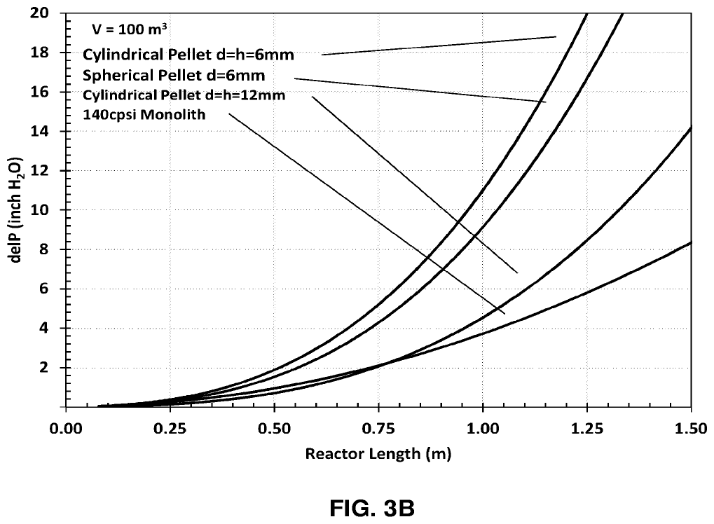

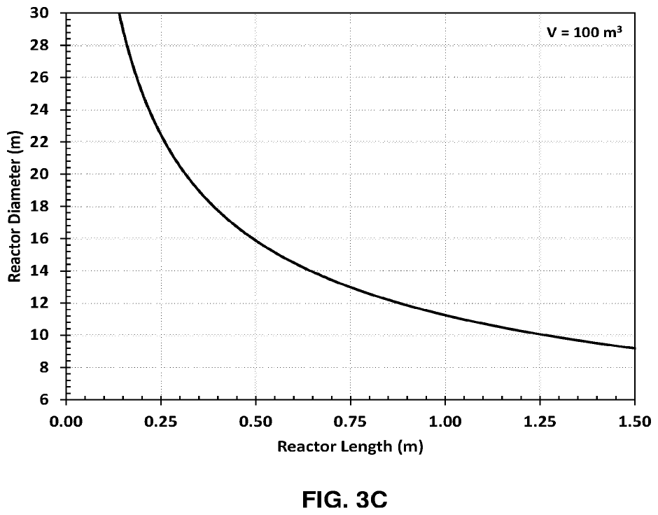

The lower operating temperature of the exothermic methane conversion reaction may all for a net energy-generating technology, where theoretical calculation shows potential for net energy output at the mega-watt scale. For example, the reaction heat generated by catalytic oxidation of the methane (assuming 1% concentration at 100,000 CFM) can increase the temperature of air methane from 310° C. at the inlet (the optimum catalytic reaction temperature identified so far) to approximately 610° C. In the system (FIG. 2), the hot ventilation air is then routed to a boiler or primary heat exchanger to drive a power cycle; that is: to heat up a working fluid such as water or steam or other, which is then used in turbine to generate electricity through a steam Rankine cycle. As the heat is extracted, the air methane is cooled down to roughly 340° C. after this process, and this excess heat can be used to preheat the incoming VAM from mines, raising it from ambient temperature to the target temperature (310° C.) for the catalytic reaction. As a result, no extra cost is incurred to heat up the incoming air (i.e., much of the work needed to heat the fluid to effective catalytic temperature is “paid for” by the reaction itself). Some of this energy can provide the power needed to overcome the pressure drop of gas flow, an inevitability in any heterogeneous catalyst-reactor system. Assuming a nominal compressor efficiency of 88%, a steam cycle efficiency of 33%, a flow rate of 100,000 CFM, and variable methane from 0.5-2% in VAM, the break-even pressure drop was found to be approximately 2 bar at 1% methane concentration and 6.8 bar at 2% methane concentration (FIG. 3A). Thus, a series of designs can be applied to the system to achieve electricity generation (i.e., pressure drops that are lower than the modeled break-even points). In this way, excess electricity can be sold to offset operating and capital expenses or meet on-site needs. Using the near break-even pressure drop of 2 bar, lifecycle assessment (LCA) and lifecycle cost assessment (LCCA) of the current modeled system (i.e., without further optimization) correspond to 89.7% lifecycle greenhouse gas offsets and a 3% internal rate of return. Pressure drop can also depend on reactor dimensions (FIGS. 3B-3C). FIG. 3B is a graph depicting the pressure drop (delta P) with reactor length and shape of the catalyst for PBR (cylindrical pellet size 6 mm, 12 mm; spherical pellet size 6 mm) and a 140 cpsi monolith catalyst with an inlet flow rate of 209,006 ft³/min at 350° C. (or 100 k ft³/min at 25° C.). FIG. 3C is a graph depicting the relationship between reactor diameter and reactor length. The carbon abatement technology described herein can pay for itself over time and provide powerplant-level energy. Exploring the novel reactor designs (three geometries proposed), such as falling particle reactors with minimal pressure drops, can lead the system to potentially generate power on the order of up to 2-5 megawatts.

The system can have a geometry of a fan-like reactor, landfill cap, or a filter style. The filter style can have heating elements embedded in or sandwiched around a catalyst bed.

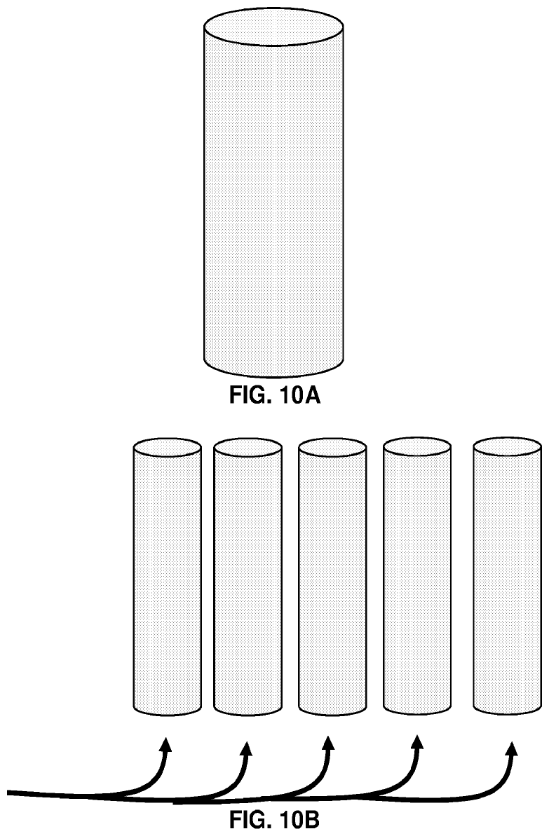

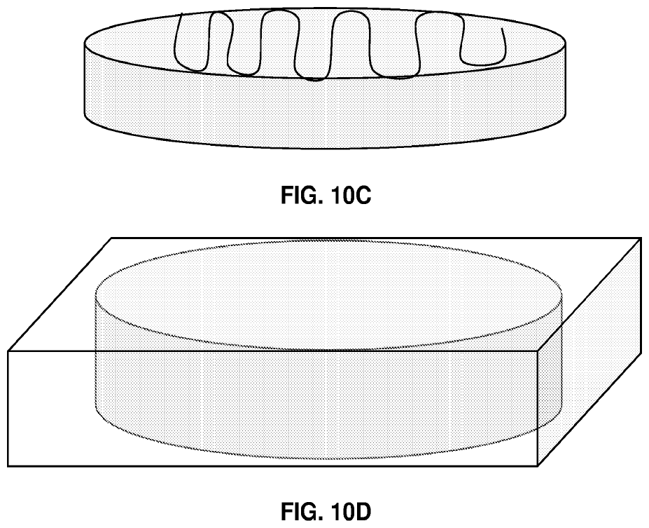

Referring to FIGS. 10A-10D, various reactor geometries can be designed for a variety of applications including: (1) a silo configuration for large volume treatment (FIG. 10A); (2) a set of parallel reactors in which large volume flows are fractionated into smaller proportional flows (FIG. 10B); (3) a thin-film filter in which heating is distributed across the filter (FIG. 10C) (i.e., as a drop-in replacement filter); or (4) a fan configuration for open air treatment or introduction of a remote source gas (FIG. 10D). In FIGS. 10A-10D, the interface to treatment source, heating configuration, heat recovery, and sensing elements are not shown. In each of FIGS. 10A-10D, treatment gas flow is through the reactive media. Applications for the reactor geometries can include landfill gas, coal mining ventilation air, dairy barn ventilation, oil and gas, or open air treatment. Each configuration of reactor can exist as cuboid, cylindrical, or other geometric adaptations. In each configuration of reactor, catalysts can be fixed, packed, floating, or hierarchically structured in all configurations. In certain circumstances, reactors can contain elements to promote gas-catalyst mixing, such as pegs or baffles.

Anticipating the broad range of input gas compositions, and the impact on the functional conversion efficiency and energetic yield in the catalytic oxidation reactor, air methane mitigation systems will require online, rapid, real-time sensing. While there is a perception that methane sensing is a solved problem, the truth is that most spectroscopic or electrochemical sensors suffer interferences with common co-contaminants (i.e., ethane, H₂S, and water), have slow response times, and are plagued by low accuracy (e.g., within a factor of 0.5-2× the actual value only 18-53% of the time for nine surveyed instruments (Ref. 11)). These accuracy rates are simply not sufficient for instrumented reactor decision making. One example of a suitable sensor is a carbon-nanotube-enabled, chemiresistive sensor that relies on platinum polyoxometalate-mediated methane oxidation reaction with response times on the order of 0.5 min, stable in air and tolerant to moisture, sensitive to at least 0.5% methane, and selective over other hydrocarbons, H₂, and CO₂. See, for example, U.S. patent application Ser. No. 17/244,188, which is incorporated by reference in its entirety (Ref. 12). In and of itself, this transformative innovation could aid fugitive methane loss detection. Note the nanotube and Pt requirements are miniscule, so the sensor cost is on the order of dollars per sensor, even at lab scale. Furthermore, the power requirements of the sensor and anticipated sensor suite are trivial (e.g., approximately 1 W) compared to other energy needs. Nevertheless, sensors can have cross-reactive responses to methane and H₂S. Systematic compositional changes in the sensors have been shown to modulate the relative responsiveness of these two gases (Ref. 13), and a more robust sensor system can be built with machine learning-enabled signal deconvolution. This approach will rely on the creation of a multi-sensor array that includes several novel binding moiety-nanotube constructs that can be quickly cycled for electrochemical signal (responding to potential interferants like H₂S, H₂O, or H₂) in a type of “electronic nose.” This array of detectors will yield unique signals and interference patterns that can be trained and interpreted to improve accuracy of detection for all analytes simultaneously.

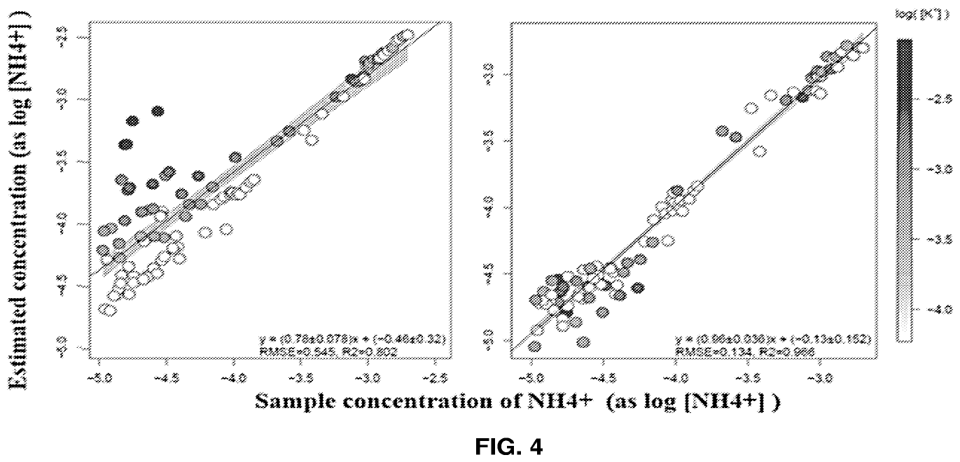

A codesign approach between sensor hardware selection and ML sensor fusion construction can be used (e.g., selection of complementary technologies to provide non-orthogonal interference and/or noise patterns, which promotes learning by the algorithm even under limited data conditions). Also, system physical models (e.g., strategic chemistries) can be hybridized into “standard” ML approaches, to facilitate learning from smaller datasets and ensure interpretable results. This approach has led to improved quantification accuracy of low-concentration nutrients in natural surface (Ref. 14) and wastewaters (Ref. 15) (FIG. 4), both of which represent complex mixtures of chemicals. This approach can be extended to air samples, and ML advances can be deployed to deconvolute methane, H₂S, and other interfering signals. Considering the explosion in sensor technologies, these ML assisted enhancements are critical to meaningful (i.e., accurate) deployment of any sensors in environmental monitoring systems.

The system can be modified or altered to meet customer needs and specifications to facilitate adoption of this important technology. For miners, there are three primary concerns to explicitly address: (1) The application of particulate calcium carbonate powder in the mine to reduce explosion hazard confers a large anticipated particle load in VAM, which can be addressed using centrifugal capture or filters; (2) The U.S. coal industry has seen steady and sharp declines, placing them under heavy financial constraint. Thus, the approach seeks not just to minimize cost of methane abatement but to generate revenue for the mine. (3) Of foremost concern is compliance with Mine Safety and Health Administration (MSHA) regulations to ensure worker safety. Specific actions can address these concerns. Thus, one of the principle technical goals of the project-to design a catalytic reactor that can tolerate high flow rates at low pressure drops—is linked to the key design challenge that will improve the economics. Capital expenditure (CAPEX) and operational expenditure (OPEX) drivers can be used to inform the design process, not simply serve as retroactive assessment. Noting the demonstrated successes in the catalyst's ability to destroy methane across a spectrum of low levels, 99.5% methane reduction can be achieved, improve real-time sensing, offer levelized net greenhouse gas emissions reductions of at least 87%, and reach a cost of carbon abatement below $40/ton CO_{2,e}. Due to the global scale of mining, this technology may feasibly halt atmospheric methane accumulation and offer near-term climate forcing benefits. (Refs. 2-5) Beyond mining, a smaller version of the system described herein can be used to address residual methane from flares, engines. A similarly scaled system can address methane emissions at dairy and meat cultivation centers where enriched methane sources exist. As a result, this device may not only stop atmospheric accumulation of methane, but begin to restore the atmosphere to its preindustrial composition and with dramatically improved economics.

Testing the impact of interfering gases on catalyst performance can be straight forward but time consuming. A 12-gas mixing apparatus can be used to emulate trace gas atmospheres (e.g., down to parts-per-million levels of gases in any diluent) that is fully automated (i.e., with electronic mass flow controllers, a laptop interface, and custom, intuitive language software). These specialized mixtures can be impinged on any reactor interface (or sensor suite), but for small-batch catalyst testing are delivered to a 1-inch vertical tube furnace interfaced to a gas chromatograph to test methane conversion rates in approximately real time (every 30-90 seconds). The vertical tube furnace ensures good contact with catalyst powders without preferential flow channels around the catalyst, but other particle geometries described below (and reactors described below) can be tested using this gas mixing and analysis system as well. The system can be entirely portable, including most of the gas tanks (i.e., lecture bottles can be used for additives like ethane, H₂S, or CH₄ itself). Primary potential interferants of concern that will be systematically evaluated include water, ethane, H₂S, and NOₓ if necessary and will be systematically delivered over a range of anticipated concentrations. These concentration ranges include water at relative humidity from 70-100% (Refs. 17-19), and ethane from 10 s to 1000 ppm (based on methane-to-ethane ratios of 38-100 or lower in coal beds or VAM (Refs. 20-22)), H₂S from a 1-100 s of ppm (based on “sour gas” thresholds of approximately 4 ppm identified in pre-sweetened natural gas; no more than 0.1%), and low levels of ammonia gas (e.g., in dairy barns) from 1-50 ppm. Note that there are few publicly available measurements of the composition of VAM or in an open air system such as a dairy barn air, but the composition is projected to be heterogeneous and will cover a wide array of possible co-variances strategically.

The trace gas analysis can allow for simulation of the precise composition of potentially interfering species at ventilation air sites. Briefly, Department-of-Transportation (DOT), passivated (i.e., H₂S-compatible) stainless steel gas canisters can be used to collect 150-mL samples of gas from which an aliquot can be draw, pre-concentrated with cryogenic focusing, and subsequently injected onto a gas chromatograph with flame ionization and thermal conductivity detection. Detection limits can be on the order of 1 ppmv. Thorough quantification and identification can be enabled through the use of authentic standards. This can lead to explicit delineation of ventilation air composition, catalyst poisoning regimes (i.e., gas combinations and durations of exposure after which catalyst performance decays), and pre-filtration needs.

The catalyst synthesis process relies on readily available techniques that require no specialized equipment. The catalyst can be in the form of a pellet, sphere, or powder. Higher order structures can be constructed. In the system described herein, loose packing of the catalyst lead to the good conversion of methane to oxidized products, for example, 80% or greater, 85% or greater, 90% or greater, 95% or greater, or about 100% conversion.

Water and H₂S could interfere with the catalyst performance in addition to other contaminants. Water is expected to “poison” methane-to-methanol catalysts at high RH (Ref. 23), and while it is unclear whether this impacts methane-to-CO₂ conversion, certain implementations of the system can address this possibility. If poisoning is identified, upstream driers or other purifiers can be added to the complete system design. Water poisoning can be reduced or eliminated by operating at 400° C. to 500° C. Catalyst poisoning by H₂S gas can also occur due to the high binding affinity of sulfides with copper (Ref. 24). The capacity of the catalyst to tolerate this anticipated effect can be assessed and modifications of the system can be devised to address this potential challenge, for example, either pre-treatment (e.g., basic scrubbing or membrane separation) or catalyst re-charge or regeneration schema if necessary. Note the ultimate selection of approach for any needed pre-treatment or recharge will be informed by cost modeling. Alternatively, the catalyst can be replaced or recharged periodically. This may not be needed, and durability and recharge strategies can be evaluated for each potential use.

Catalyst production can include the zeolite and a binder. This formulation can be extruded to form pellets or mold or shaped to take other geometric forms, including a brick, monolith, disk or other structure.

The catalyst can be on a support or binder formulation. For example, affixing the catalyst substrate to appropriately sized particles or hierarchical structures to enable fast flows of air and good catalyst-air contact is critical. Informed by reactor modeling, Cu-exchanged zeolites can be interfaced with appropriate binder formulations and particle sizes to achieve the requisite reaction and heat transfer rates with minimal attrition. Methane oxidation activity at low temperatures can be directly correlated with the size of metal nanoparticles within the zeolite framework, where smaller clusters display higher reaction rates (Ref. 15). Accordingly, catalyst performance for zeolite topologies including caged and three-dimensional pore architectures (silicoaluminate and silicoaluminophosphate) can be evaluated for activity and stability. Down-selected catalysts can be interfaced with the appropriate binders and/or adopted to coat tubes, monoliths, or fibers for reactor concepts. Note that if spherical particles are selected, the diameter and density will be important in both the pack bed reactor (PBR) and fluidized bed reactor (FBR; including the gravitational settling mode, where larger particles and geometries favor desirable lower pressure drops). Methods to control particle size are abundant, but density considerations may require more manipulation of pore structure or additives. Hierarchical material fabrication, 3D printing of metals, and advanced manufacturing can be used to support this goal, including continuous dip-coating, flow-coating, and vapor deposition (all of which are amenable to the washcoat needed for a monolithic catalytic reactor (MCR) that is often used with metal-doped zeolite catalysts in catalytic converters). Intrinsic kinetic data can be extracted, and material performance can be tested under relevant conditions. Computational fluid dynamics simulations, incorporating heat flows and measured reaction kinetics, can support this effort. It is expected that the system can achieve at least 99.5% CH₄ conversion on substrate-affixed catalysts at elevated flowrates. In addition, the residence time needed for complete methane conversion can be an important parameter—this parameter drives the reactor specifications, which in turn drive the efficiency and capital cost. Currently, a 30-s residence time has been modelled, but residence times as low as 2-s have shown efficacy (FIG. 1). It is possible that lower residence times can be effective. Residence times can be studied and minimum residence times established for particular system designs. For example, at high ventilation flowrates (100 k CFM) and a fairly large reactor diameter (7 m), a 38-m long reactor chamber can be needed to achieve a 30-s target residence time, whereas a 2.5-m long reactor chamber could achieve a 2-s residence time. Minimizing the residence time could help lower the material burden and associated build and installation costs that drive the capital expense.

Some challenges include that (a) optimizing fabrication of hierarchical materials can be challenging and (b) the possible material space is vast. Here, micro- and nano-confinement of reactive centers can be important to system design. Alumino-silicate binders can be a wonderful, low-cost medium to achieve this goal. These are available in a variety of formulations and can be manipulated using both bottom-up and top-down approaches. In certain circumstances, organic substrates can impede the efficacy (and testability) of the catalysts due to their low thermal stability and interference with direct methane conversion measurement. This can reduce the possible material space, so that materials can be chosen that are amenable to the reactors described below and the specifications delineated for PBR, FBR, and MCRs.

Developing sensor signal improvement via ML algorithm that can characterize the single- and multi-interference patterns of sulfur species, other hydrocarbons, and environmental characteristics such as relative humidity on the developed sensors. Methane (Ref. 12) and H₂S sensors can be used and additional, nano-enabled sensors (e.g., to differentiate H₂S from methane) can include reactive binding ligands to their standard platform, including metal-enabled co-valent modification of carbon nanotubes. Enhanced sensitivity can be achieved using coatings that can concentrate gases of interest and limit humidity responses. Field effect transistor methods can modulate sensitivity and selectivity by varying gate voltages. A ML signal deconvolution algorithm can analyze data from sensors arrays, commercial relative humidity (RH) monitoring, and precision gas mixing devices. Training data can adequately cover the (multidimensional) space of potential application conditions and can be sufficient, i.e., large and variable enough to properly parameterize the non-linear models utilized. Methane levels from roughly 250 ppm (lower limit of methane expected in post-reactor ventilation air assuming 99.5% destruction) to 4% (upper limit expected in incoming ventilation air), RH from 20-100%, ethane from 10-100 s ppmv, and H₂S from 1-100 s ppmv can be expected operational parameters.

It is generally not possible to identify a priori which types of learning models are best suited to analyze a novel sensor suite (Refs. 25, 26), two approaches are suggested here informed based on experience applying ML approaches to other environmental applications (Refs. 25-28). First, Gaussian (process) regression (GP) (Refs. 29, 30) is a Bayesian modeling approach that can ingest data at varying temporal scales and automatically quantifies uncertainties as a byproduct; it has proven success in multi-fidelity modeling, can enable identification of the optimal predictor set (Refs. 31, 32), and can be used for sensor fault detection (Ref. 29). The main assumption for these models can be generation of priors from the lab-based training data. Second, artificial neural networks (ANNs) can be constructed around a dot product of a nonlinear calculation, which enables explicit representation of some aspects of chemical and can enable co-prediction of multiple variables of interest (e.g., in cases where co-quantification of sulfur species may be of interest). In this approach predictor selection can be tested using a leave-one-out strategy and variance captured using bootstrap aggregating (bagging). The main challenge for this approach is appropriate balance of model complexity with size of available training data.

Packaging of sensors for field testing can require (1) design of a housing that is both weatherproof and provides controlled air flow to/across sensors and (2) integration of a controller for management of data logging and transmission. The former can be based on experience with air sensors designed for measurement of particulate matter (PM) but require close collaboration with the sensor development team to ensure residence time and flushing requirements are met. 3D printing can support rapid prototype and testing iterations. The controller, data logging, and transmission aspects will be a next-generation iteration of an existing module designed in this lab for low-power oceanographic studies (Ref. 33), with a key addition of localized real-time data transmission (e.g., Zigbee mesh networking). Note that, once the ML model is trained, calculations are fast and require little power. Overall, it is anticipated the total sensor package to demand 1 W or less energy, occupy a relatively small footprint, and can have compatibility with the Internet of Things (IoT) or simply WiFi as desired for remote monitoring and autonomous process optimization. Autonomous process optimization feedbacks and controls can be included in the system. The system can have the benefit of reduced bias and interference of the methane sensors and a field-deployable sensor housing unit.

A methane sensor can be developed that is sufficiently sensitive to monitor extremely low (i.e., post-reactor; circa 250 ppm or lower) levels of methane. First, other sensor and analytical deployments can be used. Second, a strategy to boost sensitivity of chemiresistive sensors is via the use of a polymer coating for pre-concentration or to leverage the ML interference pattern to extract the signal due to low-level methane. The durability and reliability of the sensors can be enhanced to addressed through system design over time or in a corrosive environment (e.g., if acids are generated by H₂S destruction or in high humidity). This can be systematically explored in this objective through long-duration exposures and re-testing of the sensor arrays. Strategies for reducing fouling can include pre-treatment of the streams (i.e., driers) or secondary reaction chemistry to absorb corrosive products (e.g., similar to desiccants or chemical traps). Similar sensors have small-scale manufacturing already under development and continuing in parallel with this program. Sensor hardware and controls and packaging are currently manually assembled. These can be produced in larger volumes once specified.

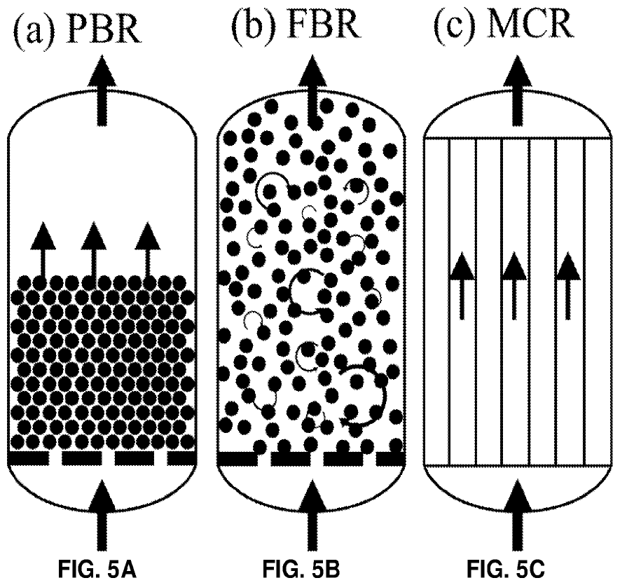

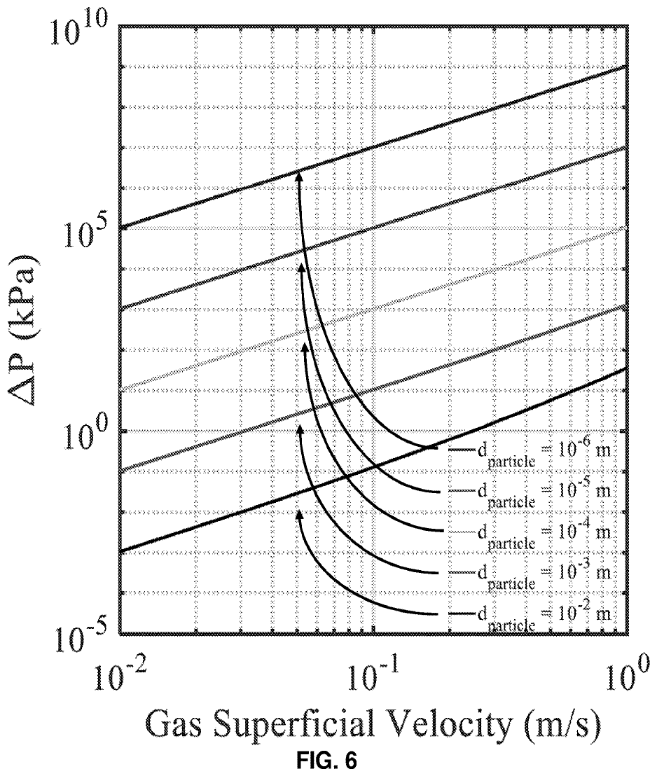

Design and modeling of the reactor can include three reactor concepts (FIGS. 5A-5C): a packed bed reactor (PBR), a fluidized bed reactor (FBR; including gravitational settling geometries), and a monolithic catalytic reactor (MCR). Each reactor can have unique trade-offs for specific requirements in the field and based on iteration of performance and consequent cost modeling impacts that can translate to the scaled version.

A PBR (FIG. 5A) is the first candidate owing to its inherently high surface area and simple design (Ref. 34). The PBR reactor, is a vessel filled with catalyst pellets, and the air flows between the pellets, interacting frequently with the active sites on the pellets as the gas is forcibly redirected between them. The high level of interaction between the gas and catalysts is what makes a PBR an effective design, but it is also the source of an inherently high pressure drop. Due to the very high gas flow rate (of a full-scale system; 500,000 to 1,000,000 SCFM) and the very low concentration of methane in the ventilation air, a significant amount of parasitic power requirement could be required to flow the gas through the system. Therefore, overcoming the gas pressure drop could be the dominant factor for the operating cost. The pressure drop can be reduced with larger pellets and lower gas velocity (FIG. 6); and larger-diameter particles with confined pore spaces can be explored. Lower gas velocity necessitates the use of larger or more reactors, and consequently higher cost, to meet the target gas flow rate. This task will determine the optimal pellet size and gas velocity exists from a performance/cost perspective.

An FBR (FIG. 5B) is another promising candidate reactor type, as its uniform particle mixing and the ability to continuously add/withdraw new pellets into the reactor is a key advantage. A preliminary reactor design can be scoped for an LCCA case (100,000 SCFM) assuming a particle size of 2 mm. Based on the calculation, the gas velocity can be over 1.18 m/s in order to suspend the pellets (i.e., fluidization) and less than 4.5 m/s to avoid particle entrainment (i.e., in which particles are carried out of the reactor by the gas). With a gas velocity of 1.2 m/s, a reactor diameter of 7 m would be 38 m tall or long for a residence time of 30 seconds. Under static conditions (i.e., before fluidization), the pellets can be packed at the bottom of the reactor (height of approximately 13 m, packing ratio 64% assuming random packing). Under operation (i.e., fluidization condition), the particles can be suspended and filled in nearly the entire reactor volume. The pellets flow for a 30-s residence time in the reactor before exiting, and this time can be further minimized (e.g., at least to 2-s in experimental testing). In the FBR, the pressure drop can be functionally used to balance the weight of the particles (200 kPa). Compared with PBRs, the increased reactor vessel size and potential particle entrainment are the drawbacks of FBRs. To overcome these challenges, an alternative design can be established where instead of suspending the particles using the gas, particles are collected at the bottom of the reactor and then recirculated via conveyor belt (FIG. 7). This “falling particle” concept has been developed for other commercial applications and may present a unique opportunity to balance high flow rate and high catalyst exposure needs of the ventilation air application.

MCRs are a very common type of reactor used for environmental applications where a catalyst is needed to eliminate a contaminant at high flow rates with high conversion efficiencies (Ref. 35). The most obvious example of this is in vehicle catalytic converters, which actually use a metal impregnated zeolite as the catalyst (i.e., catalysts for low-level methane abatement) (Refs. 36, 37). The mass-manufacturing of these monoliths can translate to lower reactor costs and faster commercialization. The MCR (FIG. 5C) can include extruded monoliths containing a grid of parallel ducts with square or hexagonal cross sections through which the gas flows. The catalyst can be adhered to the duct walls using a washcoat that is 20-40 μm thick (Ref. 38). The monolith can be made from ceramics (e.g., cordierite), or metals (e.g., copper), or the zeolite catalyst itself (as discussed herein).

The central benefit of MCRs is their ability to handle large volumes of air with reduced pressure drops compared to PBR. However, since there is less direct interaction between the gas and the catalyst, it is expected that a longer reactor will be required to achieve the same conversion. The additional capital costs associated with this might be offset by the reduced energy consumption and lower input catalyst mass, and this tradeoff can be explored with explicit models and iteration between the tasks described herein. Additional considerations can include the impact on catalyst poisoning (i.e., lower lifetime due to lower catalyst mass and consequently lower capacity), durability, and longevity. Computational fluid dynamics simulations, incorporating heat flows and reaction kinetics can be conducted to see what best supports catalyst-ventilation air contact that can achieve the desired outcomes. A key outcome of this task will be evaluation of these tradeoffs and the identification of the favored type of reactor from both an economic and functional performance perspective; ultimately informing the type of integrated reactor is scaled for extended lab testing. Other system components (sensors, controls, pre-filter scrubbers and particle filters) can be scoped and iteratively inform design choices, where the pre-filtration needs will be the largest cost driver. A system can be reactor design that offers <$50/ton CO_{2,e} and >80% GHG benefit.

In certain circumstances, pre-filtration can be an important component of a system. Pre-filtration must be able to tolerate extreme ventilation air flow rates; there are several viable strategies (e.g., centrifugal particle separation, filters, filter bags, and wet scrubbing). Wet scrubbing is well established principle that relies on acid-base chemistry to remove acidic gases (CO₂ and H₂S) using basified water (e.g., with amines or other bases). Ammonia gas could be removed with an acidic wet scrubber. These have the drawback of humidifying the input stream. If water is identified as a poisoning agent, a drying system component could to be added or other mitigation strategy used (e.g., increasing the operating temperature to 500° C.). Commercial drying units exist for other air abatement technologies that use platinum group metals, so drying is not a commercialization limitation, but does add cost. Here, novel, selective membranes could potentially provide an effective, alternative solution or contingency plan if wet scrubbing is not tractable. This presents a moderate time risk, if needed, considering H₂S separation membranes do not yet exist. For dust separation, a necessity that emerges from the calcium carbonate powder (added in mine to reduce explosion hazard for MSHA compliance), centrifugal or inertial separation is favored because it does not require the changing of filters or any other consumable component. Instead, the flow path can be leveraged to result in an inertial separation, where particles can be collected and removed without interruption or pressure drop. Gravitationally settled particles could be autonomously or continuously removed (i.e., with a mechanical trap that does not interrupt operation), or simply diverted into a large collection quarry. Filter bags are also used in large-scale industrial applications. Here, the precise concentration of particles in the treatment air are not known, and so it is difficult to estimate the mass of dust that will be collected and necessary rate of removal of collected particles.

The device is an integrated ventilation abatement system with catalytic oxidation that can include machine-learning enhanced real time sensing. The system can integrate with operational ventilation shafts or fans that are collected into a ventilation air stream, sense the composition of incoming air, separate any needed materials (i.e., particles or H₂S), react methane to CO₂, provide real-time control of important process parameters, and sense the composition of outgoing air to ensure effective treatment of methane. For example, in a dairy operation, output can be collected from each fan into a single stream for conversion. Possible sites include coal and mineral mines, as well as dairy barns, landfills, and oil and gas fields. Because the catalyst works down to ambient methane concentrations and the engineering flow dynamics will scale down, longer term market entries will include dairy farm air handling methane abatement units and even the other markets.

### Copper Mordenite Synthesis

Ammonium mordenite zeolite powder (5±0.1 g; Alpha Aesar) was stirred with 0.05 M copper nitrate solution (500 mL) for 22-26 h and then vacuum-filtered through a glass fiber filter (0.7 ism GFF). Filtered solids of copper mordenite were dried at 130° C. for 10-14 h, transferred to a glass vial, and stored in a desiccator until use. Importantly, it is noted that this preparation route is benign and strives to meet Green Chemistry principles: the ion exchange occurs at room temperature with minimized volumes and relies on earth-abundant, non-toxic materials, without acidic or organic solvents, with low energy requirements, and without the need for exotic or complex, multi-step syntheses. The process was highly reproducible.

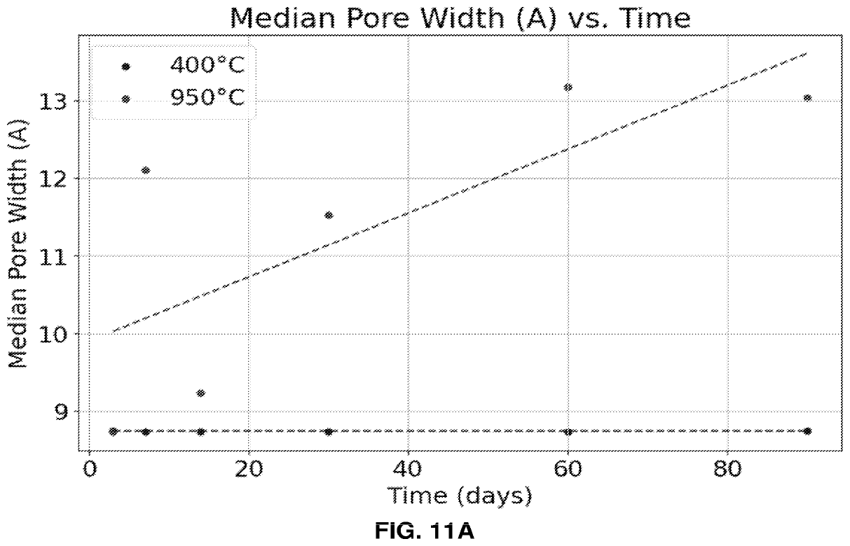

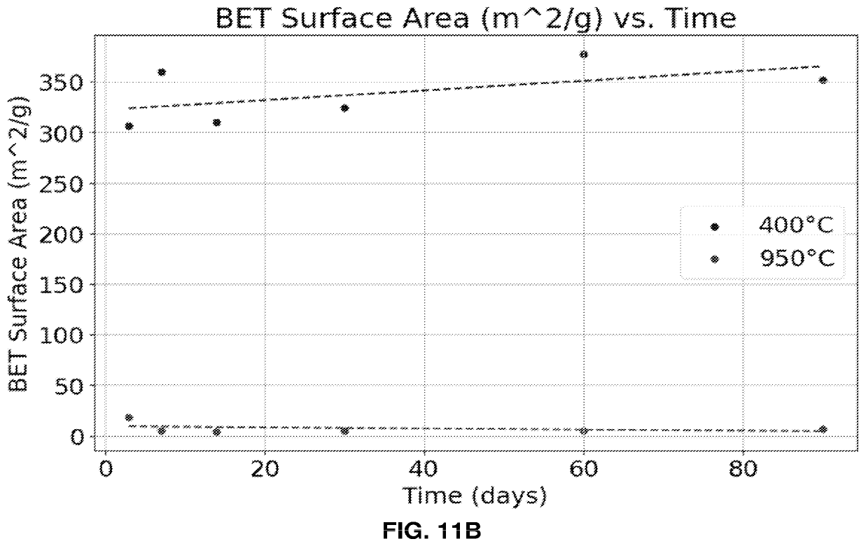

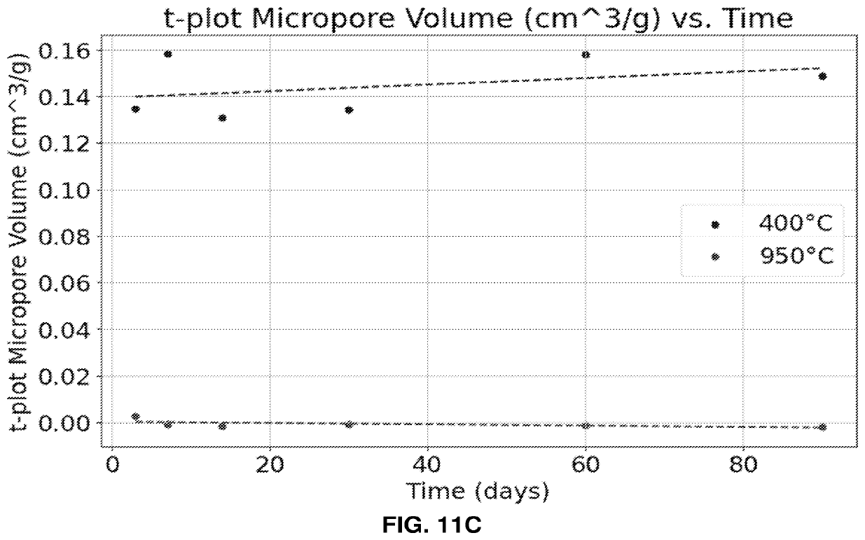

FIGS. 11A-11C show the stability of the copper mordenite catalyst of the reactor under reaction conditions. At an operating temperature of 400° C., the pore width, BET surface area and micropore volume of the catalyst is substantially unchanged over a period of over three months. In contrast, the pore width, BET surface area and micropore volume increased with time at 950° C. over the same time period. (FIGS. 11A-11C) The catalyst offers low temperature operation and better durability.

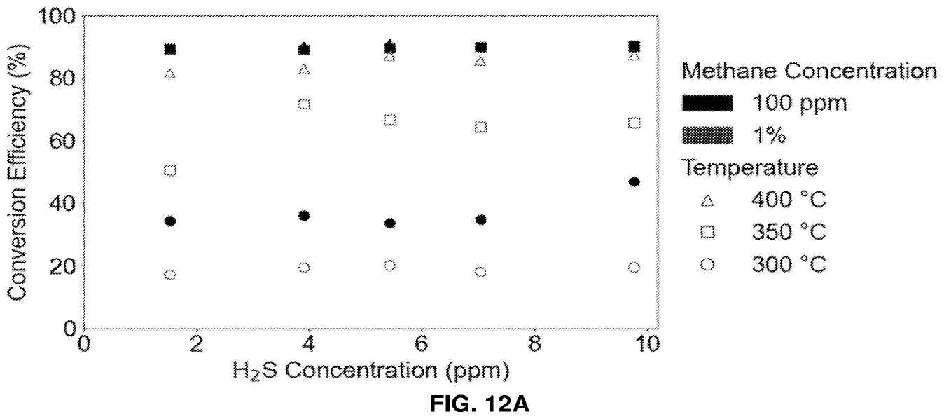

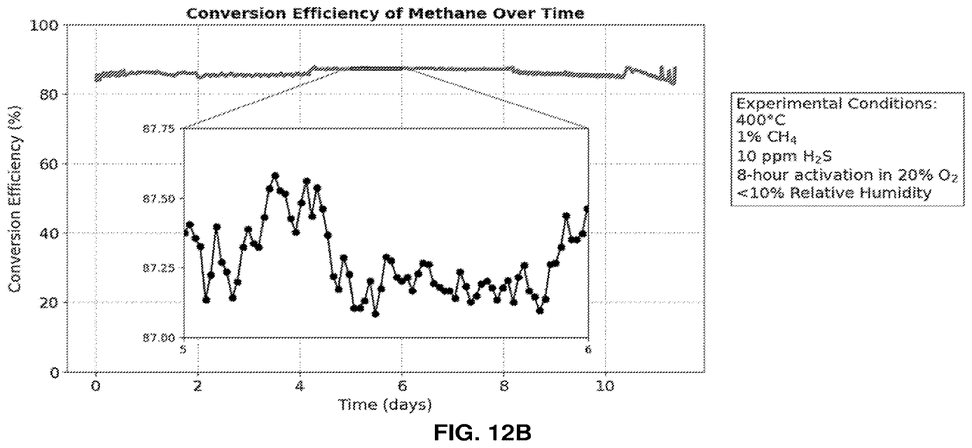

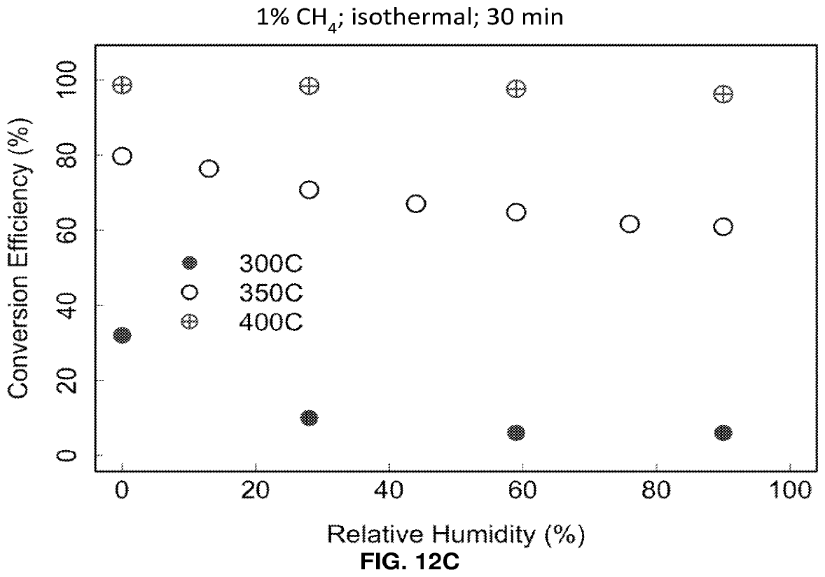

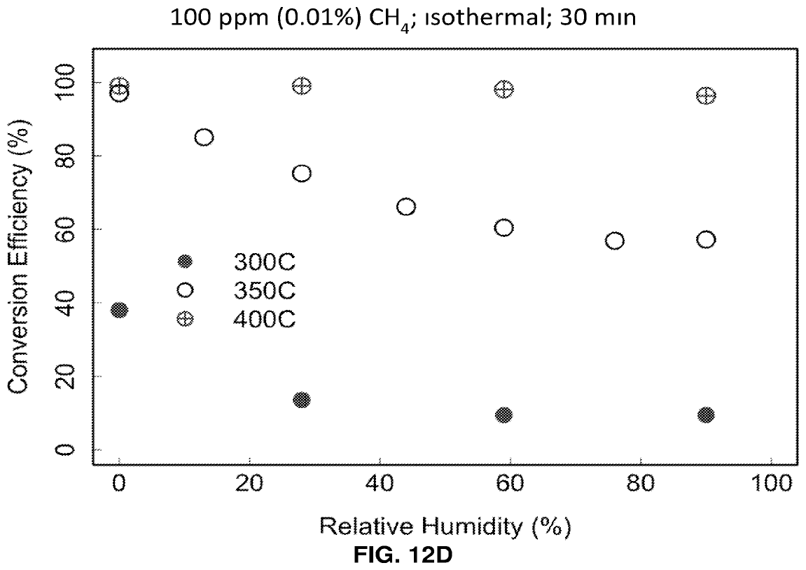

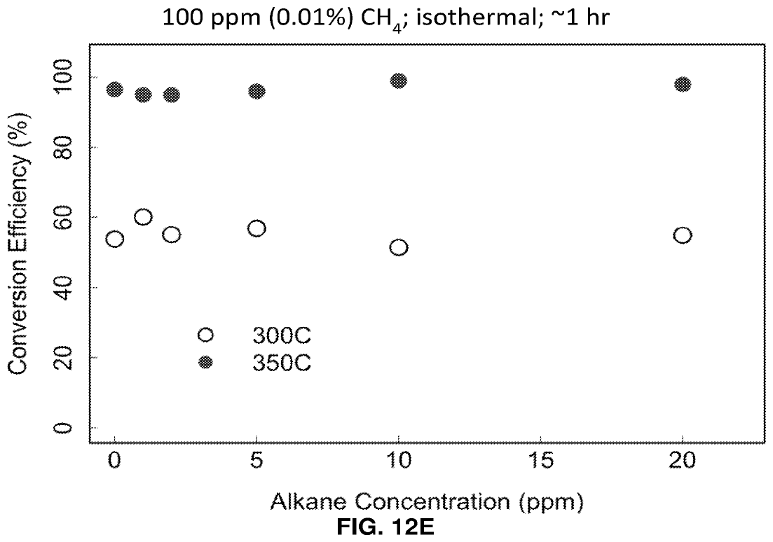

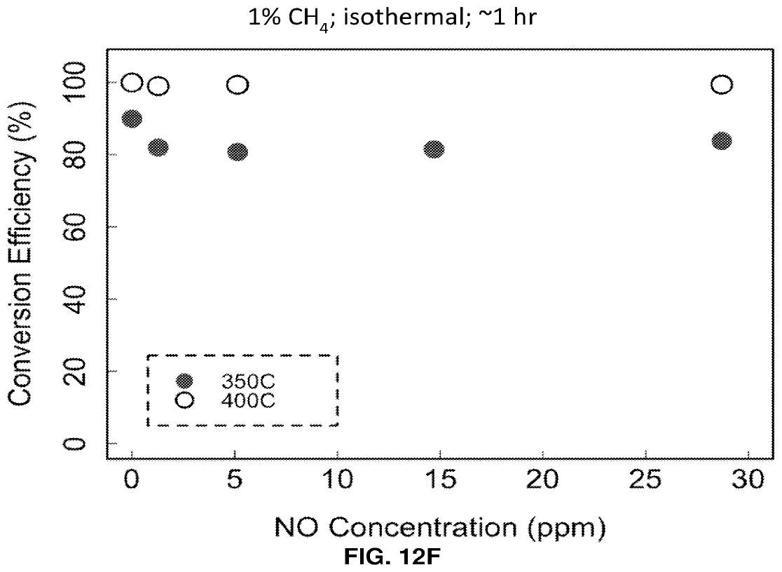

Surprisingly, the catalyst is resistant to poisoning by hydrogen sulfide or water. FIG. 12A shows the methane conversion efficiency of the copper mordenite catalyst of the reactor at 300° C., 350° C. and 400° C. in the presence of between 0 and 10 ppm hydrogen sulfide in the reactor gas. The filled symbols were run at 100 ppm methane and the open symbols were run at 1% methane. The conversion efficiency is unchanged in the presence of hydrogen sulfide. The stability of the conversion efficiency in the presence of hydrogen sulfide over a ten day period is shown in FIG. 12B. The conversion efficiency of methane of the copper mordenite catalyst of the reactor at 400° C. is substantially unchanged with time. FIG. 12C shows the methane conversion efficiency of the copper mordenite catalyst of the reactor at 300° C., 350° C. and 400° C. at 1% methane over 30 minutes in the presence of between 0 and 90% relative humidity in the reactor gas. FIG. 12D shows the methane conversion efficiency of the copper mordenite catalyst of the reactor at 300° C., 350° C. and 400° C. at 0.01% (100 ppm) methane over 30 minutes in the presence of between 0 and 90% relative humidity in the reactor gas. The conversion efficiency is substantially unchanged with humidity, particularly at 400° C. FIG. 12E shows the methane conversion efficiency of the copper mordenite catalyst of the reactor at 300° C. and 350° C. at 0.01% (100 ppm) methane over one hour in the presence of a mixture of between 0 and 20 ppm of each of methane, ethane, propane, butane, and pentane (each at the indicated concentration (e.g., the sum is greater than shown on the axis)) in the reactor gas. The conversion efficiency was complete for all alkanes. FIG. 12F shows the methane conversion efficiency of the copper mordenite catalyst of the reactor at 350° C. and 400° C. at 1% methane over one hour in the presence of a mixture of between 0 and 30 ppm of NO in the reactor gas. The conversion efficiency substantially unchanged in the presence of NO, particularly at 400° C. The catalyst can be resistant to poisoning by H₂S, NOₓ, NH₃, volatile organic compounds (VOCs), and H₂O.

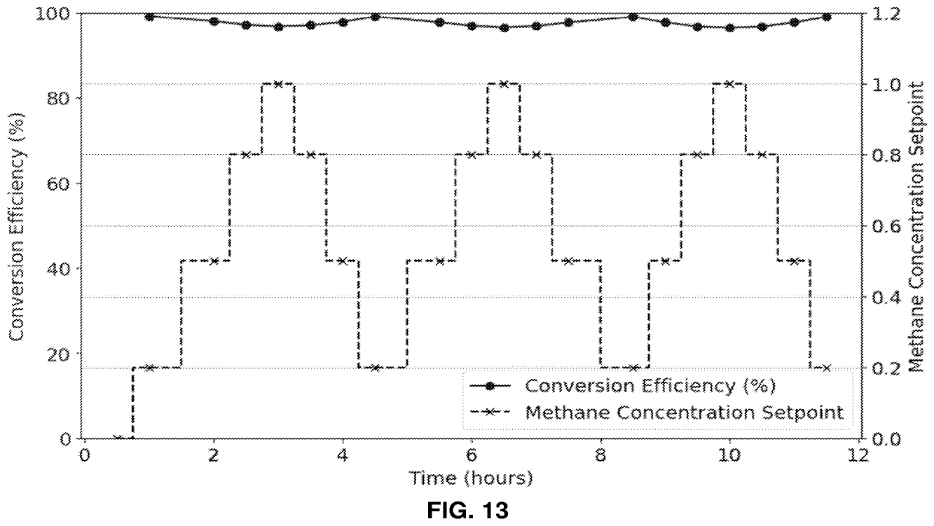

FIG. 13 is a graph depicting the responsiveness of the copper mordenite catalyst of the reactor to changes in methane concentration. A five-fold increase in methane concentration (from 0.2% to 1.0%) results in an insubstantial decrease in oxidation conversion efficiency. The decrease is on the order of 3-5% and increases to near 100% when the methane concentration is lowered.

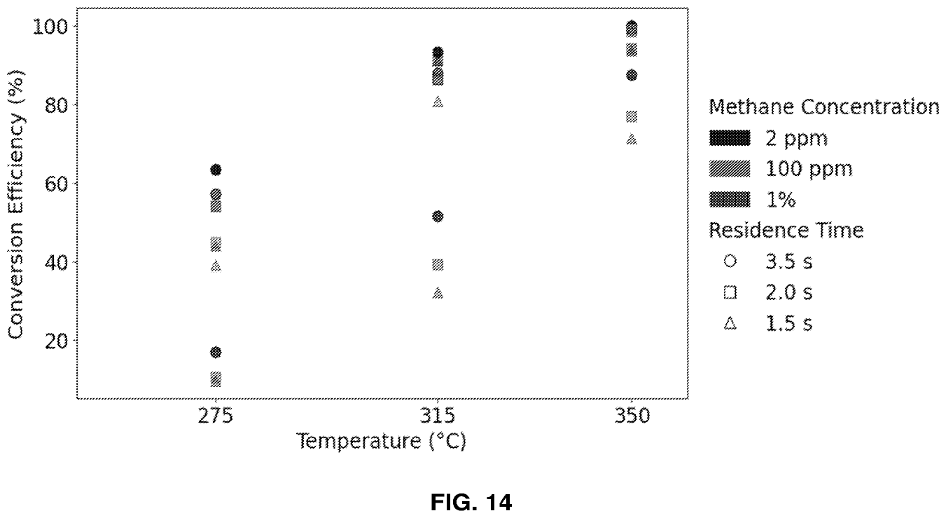

FIG. 14 is a graph depicting kinetics for oxidation of methane with the copper mordenite catalyst of the reactor. Longer residence time increases the conversion efficiency of the catalyst at higher methane concentrations. Longer residence time increases the conversion efficiency of the catalyst at lower temperatures.

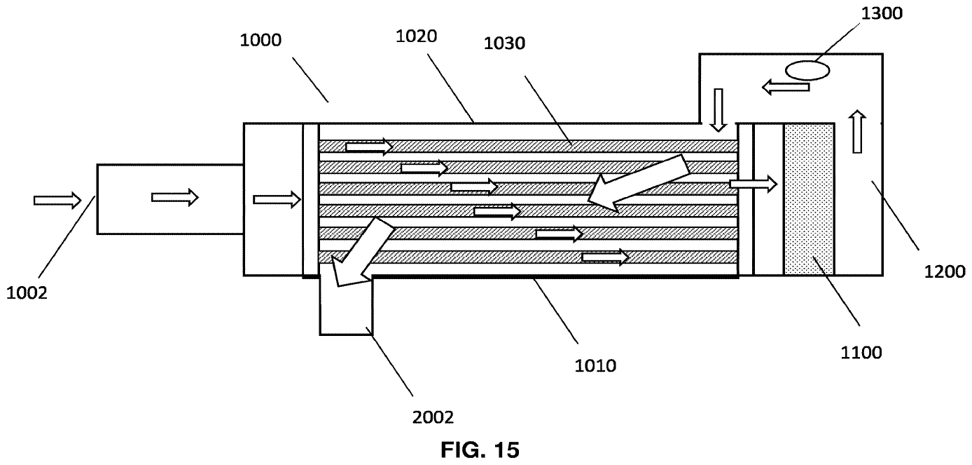

FIG. 15 is a schematic of a reactor including a heat exchanger. The heat exchanger has a flow path for the methane containing input gas that receives heat from the hot exit gas. The heat passes from the exit gas through a separating wall to the input gas. Reactor 1000 included a housing 1010. Housing 1010 include a gas intake 1002. The intake can include fans that help draw the input gas into the reactor (not shown). Tubes 1030 (shaded) pass through chamber 1020 creating a gas flow path for the input gas from the intake 1002 to the catalyst bed 1100. The gas passing through the catalyst enters return chamber 1200. Return chamber 1200 creates a gas flow path back over the outside surfaces of tubes 1030 to outlet 2002. Return chamber 1300 includes a heating element that can be used to preheat the gas flow and catalyst region or supply heat for catalyst conditioning. The gas flow through the reactor follows the white arrows in this example in a counter current flow design. The design can provide a wider operational range of input methane concentrations using this thermal control strategy. The heat recovery system depicted here does not add a substantial change in operating pressure at the heat exchanger. The system is resilient. Methane content of up to 1% does not cause temperatures exceeding service temperature of the constituent materials. The system can be balanced and run on self sustained heat generation once started without encountering a runaway condition.

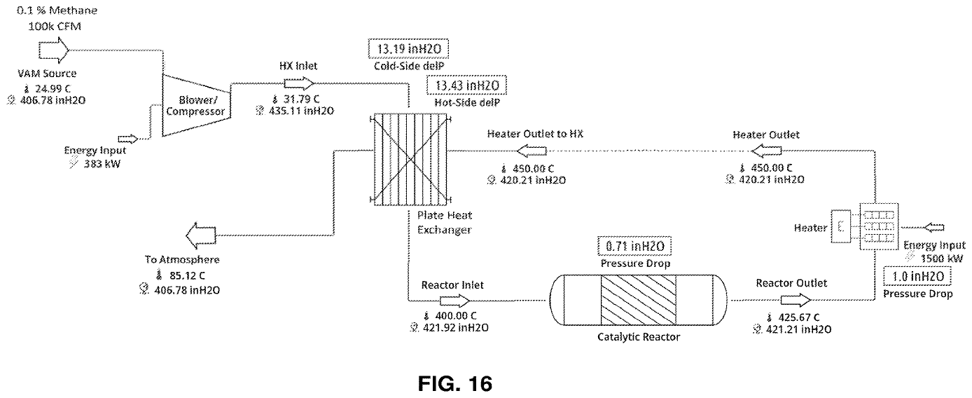

FIG. 16 is a schematic drawing showing a reactor system including exemplary conditions. In the schematic drawing a heat exchanger is identified as HX. An optional heater is shown after the reactor outlet, which can be used to maintain the operating temperature of the reactor when methane is not present in the input gas.

The references cited above in parenthesis (“( )”) include the following references. Each reference is incorporated by reference in its entirety.

### REFERENCES

1. Program, U. E. C. M. O. U.S. Underground Coal Mine Ventilation Air Methane Exhaust Characterization. (2010).
2. US EPA. Inventory of U.S. Greenhouse Gas Emissions and Sinks, EPA 430-R-21-005. (2020).
3. US EPA. Inventory of U.S. Greenhouse Gas Emissions and sinks, EPA 430-R-004. (2003).
4. British Petroleum. BP Statistical Review of World Energy. (2015).
5. Saunois, M. et al. The Global Methane Budget 2000-2017. 1561-1623 (2020).
6. Karacan, C. Ö., Ruiz, F. A., Cotè, M. & Phipps, S. Coal mine methane: A review of capture and utilization practices with benefits to mining safety and to greenhouse gas reduction. Int. J. Coal Geol. 86, 121-156 (2011).
7. Fernández, J., Marín, P., Díez, F. V & Ordóñez, S. Combustion of coal mine ventilation air methane in a regenerative combustor with integrated adsorption: Reactor design and optimization. Appl. Therm. Eng. 102, 167-175 (2016).
8. Marín, P., Vega, A., Díez, F. V & Ordóñez, S. Control of regenerative catalytic oxidizers used in coal mine ventilation air methane exploitation. Process Saf. Environ. Prot. 134, 333-342 (2020).
9. Hinde, P. et al. COMET®—A New VAM Abatement Technology. Johnson Matthey Technol. Rev., 60, 211-221 (2016).
10. MarketInsite. Nasdaq May 2021 Review and Outlook. (2021).
11. Ravikumar, A. P. et al. Single-blind inter-comparison of methane detection technologies—results from the Stanford/EDF Mobile Monitoring Challenge. Elem. Sci. Anthr. 7, (2019).
12. Bezdek, M. J., Luo, S. X. L., Ku, K. H. & Swager, T. M. A chemiresistive methane sensor. Proc. Natl. Acad. Sci. U.S.A. 118, 1-6 (2021).
13. Bezdek, M. J.; Luo, S.-X. L.; Liu, R. Y.; He, Q.; Swager, T. M. Trace Hydrogen Sulfide Sensing Inspired by Polyoxometalate-Mediated Aerobic Oxidation. ACS Cent. Sci. In press, (2021).
14. Mueller, A. V. & Hemond, H. F. Extended Artificial Neural Networks: Incorporation of A Priori Chemical Knowledge Enables Use of Ion Selective Electrodes for In-Situ Measurement of Ions at Environmentally Relevant Levels. Talanta 117, 112-118 (2013).
15. Mueller, A. V. & Hemond, H. F. Statistical generation of training sets for measuring NO₃⁻NH₄⁺ and major ions in natural waters using an ion selective electrode array. Environ. Sci. Process. Impacts 18, 590-599 (2016).
16. International Energy Agency. Coal 2020. (2020).
17. Setiawan, A., Kennedy, E. M. & Stockenhuber, M. Development of Combustion Technology for Methane Emitted from Coal-Mine Ventilation Air Systems. Energy Technol. 5, 521-538 (2017).
18. Fernández, J., Marín, P., Díez, F. V. & Ordóñez, S. Coal mine ventilation air methane combustion in a catalytic reverse flow reactor: Influence of emission humidity. Fuel Process. Technol. 133, 202-209 (2015).
19. Bae, J. S., Jin, Y., Huynh, C. & Su, S. Biomass-derived carbon composites for enrichment of dilute methane from underground coal mines. J. Environ. Manage. 217, 373-380 (2018).
20. Ripepi, N. et al. Determining coalbed methane production and composition from individual stacked coal seams in a multi-zone completed gas well. Energies 10, 10-12 (2017).
21. U.S. Geological Survey. Coalbed Methane Potential in the Appalachian States of Pennsylvania, West Virginia, Maryland, Ohio, Virginia, Kentucky, and Tennessee—An Overview.
22. Bureau of mines—U.S. Department of the Interior. The Composition of Coalbed Gas (Report of Investigations 7762). (1973).
23. Narsimhan, K., Iyoki, K., Dinh, K. & Román-Leshkov, Y. Catalytic Oxidation of Methane into Methanol over Copper-Exchanged Zeolites with Oxygen at Low Temperature. ACS Cent. Sci. 2, 424-429 (2016).
24. Morel, F. M. M. & Hering, J. G. Principles and Applications of Aquatic Chemistry. (1993).
25. Bokade, R. et al. A Cross-Disciplinary Comparison of Multimodal Data Fusion Approaches and Applications: Accelerating Learning Through Trans-Disciplinary Information Sharing. <Submitted>. Expert Syst. Appl.
26. Chou, C. A., Jin, X., Mueller, A. & Ostadabbas, S. Multimodal data fusion-moving from domain-specific algorithms to transdomain understanding for accelerated solution development. IEEE Sensors Lett. 3, 1-4 (2019).
27. Raoufi, R., Beighley, R. E. & Mueller, A. Application of Machine Learning in Estimating Global Minimum and Maximum Daily Air Temperatures Using MODIS Land Surface Temperature. <Submitted>. J. Photogramm. Remote Sens.
28. Codden, C. et al. Improved, Lower Cost Prediction of Dissolved Organic Carbon in Dynamic Aquatic Systems via Machine Learning. <Submitted>. Liminology Oceanogr. Methods.
29. Garnett, R., Osborne, M. A. & Roberts, S. J. Bayesian optimization for sensor set selection. Proc. 9th ACM/IEEE Int. Conf. Inf. Process. Sens. Networks, IPSN '10 209-219 (2010) doi: 10.1145/1791212.1791238.
30. Osborne, M. A., Garnett, R. & Roberts, S. J. Gaussian Processes for Global Optimization. 3rd Int. Conf. Learn. Intell. Optim. LION3 1-15 (2009).
31. Parussini, L., Venturi, D., Perdikaris, P. & Karniadakis, G. E. Multi-fidelity Gaussian process regression for prediction of random fields. J. Comput. Phys. 336, 36-50 (2017).
32. Perdikaris, P., Venturi, D., Royset, J. O. & Karniadakis, G. E. Multi-fidelity modelling via recursive co-kriging and Gaussian-Markov random fields. Proc. R. Soc. A Math. Phys. Eng. Sci. 471, (2015).
33. Mueller, A. V., Crusius, J., Agudelo, A. & Shaikh, F. A novel high-resolution trace metal clean sampler for stationary, profiling, and mobile deployment. 2018 Ocean.—MTS/IEEE Kobe Techno-Oceans, Ocean.—Kobe 2018(2018) doi:10.1109/OCEANSKOBE.2018.8559270.
34. Nemec, D. & Levec, J. Flow through packed bed reactors: 1. Single-phase flow. Chem. Eng. Sci. 60, 6947-6957 (2005).
35. Heck, R. M., Farruto, R. J. & Gulati, S. T. “Catalytic Air Pollution Control: Commercial Technology”, 3rd Edition. (2009). doi:10.1595/147106710x511015.
36. Brenneis, R. J., Johnson, E. P., Shi, W. & Plata, D. L. Atmospheric- and Low-Level Methane Abatment via an Earth-Abundant Catalyst. <Submitted>. ACS Sustain. Chem. Eng.
37. Plata, D. L., Brenneis, R. J. & MIT. Abatement of Low Level Methane Through the Use of Catalytic, Earth Abundant Materials, Application No. 63/190,404. (2021).
38. Govender, S. & Friedrich, H. B. Monoliths: A review of the basics, preparation methods and their relevance to oxidation. Catalysts 7, (2017).

Other embodiments are within the scope of the following claims.

What is claimed is:

1. A system for oxidizing methane comprising:
a reactor housing including:
a feed gas stream intake;
an oxidation region including a methane oxidation catalyst configured to contact a feed gas stream including methane from the gas stream intake; and
a gas stream outlet opposite conversion region for the activated methane oxidation catalyst to convert the feed gas stream to an oxidized product at a conversion temperature in the presence of an oxidative agent,
wherein the activated methane oxidation catalyst is activated at an activation temperature at or below about 500° C. while the oxidative agent includes less than 100% oxygen.

2. The system of claim 1, further comprising at least one sensor configured to monitor real-time input feed composition of one or more interfering species.

3. (canceled)

4. The system of claim 2, wherein the sensor is a chemiresistive sensor.

5. (canceled)

6. The system of claim 1, further comprising a signal deconvolution module for analyzing one or more sensor signals, the signal deconvolution module including a machine learning analysis protocol.

7. (canceled)

8. The system of claim 1, further comprising a feedback control system.

9. The system of claim 8, wherein the feedback control system adjusts one or more of input feed gas methane concentrations or oxidative agent concentration.

10. (canceled)

11. The system of claim 1, wherein the feed gas stream includes entrained particles.

12. The system of claim 1, wherein the feed gas stream has a flow rate of between 0.5-1 million cubic feet per minute (CFM).

13. The system of claim 1, wherein the feed gas stream has a flow rate of less than 100 CFM.

14. The system of claim 1, wherein the conversion temperature is less than about 500° C.

15. The system of claim 1, wherein the activated methane oxidation catalyst is activated at an activation temperature at or below about 350° C. while exposed to an activation gas including less than 40% oxygen for an activation time.

16. (canceled)

17. The system of claim 1, wherein the oxidation region includes a fixed bed including the methane oxidation catalyst.

18. The system of claim 1, further comprising a heat exchanger configured to flow heat from the oxidized product to the feed gas stream.

19. The system of claim 1, wherein the methane oxidation catalyst includes an iron zeolite, a nickel zeolite, a copper zeolite, or combinations thereof.

20. (canceled)

21. (canceled)

22. (canceled)

23. A method of oxidizing methane comprising:
sensing one or more features of a feed gas mixture; and
exposing the feed gas mixture including methane in the presence of an oxidative agent to a methane oxidation catalyst to convert the methane to an oxidized product, the feed gas mixture having a methane content between about 0.1% and about 2.0% prior to conversion and the oxidative agent having less than 100% oxygen.

24. The method of claim 23, wherein the one or more features of the feed gas mixture provides feedback for conditions of the exposing step.

25. (canceled)

26. (canceled)

27. (canceled)

28. (canceled)

29. (canceled)

30. (canceled)

31. (canceled)

32. The method of claim 23, wherein the oxidative agent includes less than 22% oxygen.

33. (canceled)

34. (canceled)

35. The method of claim 23, wherein the oxidative agent includes one or more of a solid with metal cofactors such as iron, silver, manganese, or lead, or a liquid, such as hydrogen peroxide, hypohalous acids and equilibrating species, or dissolved peroxidases.

36. A system for oxidizing methane comprising:
a reactor housing including:
a feed gas stream intake, the feed gas stream having a methane content between about 0.1% and about 2.0%;
an oxidation region including a methane oxidation catalyst configured to contact a feed gas stream including methane from the gas stream intake; and
a gas stream outlet opposite conversion region for the activated methane oxidation catalyst to convert the feed gas stream to an oxidized product at a conversion temperature in the presence of an oxidative agent.

37. The system of claim 35, wherein the feed gas stream has a methane content of about 1.8 ppm to up to about 1%.
